(19) United States
(12) Patent Application Publication
(10) Pub. No.: US 2023/0298240 A1
(43) Pub. Date: Sep. 21, 2023

(54) CONTROL PROGRAM FOR TERMINAL DEVICE, TERMINAL DEVICE, CONTROL METHOD FOR TERMINAL DEVICE, CONTROL PROGRAM FOR SERVER DEVICE, SERVER DEVICE, AND CONTROL METHOD FOR SERVER DEVICE

(71) Applicant: GREE, Inc., Tokyo (JP)

(72) Inventor: Daiki HAYATA, Tokyo (JP)

(73) Assignee: GREE, Inc., Tokyo (JP)

(21) Appl. No.: 18/090,533

(22) Filed: Dec. 29, 2022

(30) Foreign Application Priority Data
Mar. 17, 2022 (JP) 2022-042723

(51) Int. Cl. G06T 13/00; G06F 3/0482; G06F 3/14; G06F 3/16

(52) U.S. Cl. CPC G06T 13/00; G06F 3/0482; G06F 3/14; G06F 3/16

(57) ABSTRACT

A control method includes displaying, by a terminal device of a first user, a first image including a first object indicating the first user, and a second image including a second object indicating a second user; sending, from the terminal device of the first user to a terminal device of the second user, information relating to display of the first image; displaying the first image including the first object as being changed in accordance with an action or first audio data of the first user; displaying the second image including the second object as being changed in accordance with an action or second audio data of the second user; and displaying the first image including the first object as being changed in accordance with an instruction from the first user and displaying the second image as being changed in accordance with the instruction from the first user.

### CROSS-REFERENCE TO RELATED APPLICATIONS

The present application claims the benefit of priority to Japanese Application No. 2022-042723, filed in Japan on Mar. 17, 2022, the entire contents of which is incorporated by reference.

### TECHNICAL FIELD

The present disclosure relates to a control program for a terminal device, a terminal device, a control method for a terminal device, a control program for a server device, a server device, and a control method for a server device.

### BACKGROUND

Conventionally, multiple users communicate with each other by sending various types of information, such as images and/or voices of users, using their terminal devices, such as personal computers (PCs), to each other. For example, information systems may implement voice chat between users by letting them share users' images and voices obtained from cameras and microphones installed in their PCs connected to the internet.

### SUMMARY

In an exemplary implementation of the present disclosure, a control method comprises displaying, on a display of a terminal device of a first user, a first image and a second image, the first image including a first object indicating the first user, the second image including a second object indicating a second user, and the second user being different from the first user; sending, from the terminal device of the first user to a terminal device of the second user via a network, information relating to display of the first image; sending first audio data of the first user to the terminal device of the second user via the network in a case that the terminal device of the first user obtains the first audio data of the first user; displaying the first image including the first object as being changed in accordance with an action or the first audio data of the first user; outputting second audio data of the second user, received via the network, in a case that the terminal device of the first user obtains the second audio data of the second user; displaying the second image including the second object as being changed in accordance with an action or the second audio data of the second user; and displaying the first image including the first object as being changed in accordance with an instruction from the first user and displaying the second image as being changed in accordance with the instruction from the first user.

### BRIEF DESCRIPTION OF THE DRAWINGS

FIGS. 1A, 1B, and 1C are schematic views for explaining an example of an overview of an information system;

FIG. 2 illustrates an example of the schematic configuration of the information system;

FIG. 3 illustrates an example of the schematic configuration of a terminal device;

FIGS. 4A, 4B, and 4C illustrate examples of the data structures of various tables;

FIG. 5 illustrates an example of the schematic configuration of a server device;

FIGS. 6A and 6B illustrate examples of screens displayed on a display of the terminal device;

FIGS. 7A and 7B illustrate examples of screens displayed on the display of the terminal device;

FIGS. 8A and 8B illustrate examples of screens displayed on the display of the terminal device;

FIGS. 9A and 9B illustrate examples of screens displayed on the display of the terminal device;

FIGS. 10A and 10B illustrate examples of screens displayed on the display of the terminal device;

FIGS. 11A and 11B illustrate examples of screens displayed on the display of the terminal device;

FIGS. 12A and 12B illustrate examples of screens displayed on the display of the terminal device;

FIGS. 13A and 13B illustrate examples of screens displayed on the display of the terminal device;

FIGS. 14A and 14B illustrate examples of screens displayed on the display of the terminal device;

FIGS. 15A and 15B illustrate examples of screens displayed on the display of the terminal device;

FIG. 16 illustrates an example of an operation sequence of the information system;

FIGS. 17A and 17B illustrate examples of screens displayed on the display of the terminal device; and

FIG. 18 is a schematic view for explaining a virtual space.

### DETAILED DESCRIPTION

The inventors of the present disclosure have recognized that, while a user is communicating with another user, he/she may lose interest in communication due to lack of variety of output from a terminal device of the user. The inventors of the present disclosure have recognized that it is therefore desirable to provide a control program for a terminal device, a terminal device, a control method for a terminal device, a control program for a server device, a server device, and a control method for a server device that make it possible to encourage a user to continue communicating with another user.

A control program for a terminal device according to the present disclosure is a control program for a terminal device of a first user. The control program causes the terminal device of the first user to execute: displaying at least a first image and a second image, the first image including a first object indicating the first user, the second image including a second object indicating a second user, the second user being different from the first user; sending information concerning the displaying of the first image to a terminal device of the second user; sending a first voice of the first user to the terminal device of the second user if the first voice of the first user is obtained; displaying the first image including the first object which is to be changed in accordance with an action or the first voice of the first user; outputting a second voice of the second user if the second voice of the second user is obtained; displaying the second image including the second object which is to be changed in accordance with an action or the second voice of the second user; and displaying the first object which is changed in accordance with an instruction from the first user and also displaying the second image which is changed in accordance with the instruction from the first user.

In the control program for the terminal device, in the displaying of the changed first object, the terminal device of the first user may be caused to execute: displaying the first object which performs a first action corresponding to the instruction from the first user. In the displaying of the changed second image, the terminal device of the first user may be caused to execute: displaying the second object which performs a second action, the second action being related to the first action, in accordance with the first action of the first object or displaying information concerning the first action of the first object.

In the control program for the terminal device, the instruction from the first user may include an instruction to select the first action to be performed by the first object from plural first actions and include an instruction to select the second object which is to perform the second action or to select the second image including the second object which is to perform the second action.

In the control program for the terminal device, if a condition concerning a relationship between the first user and the second user is satisfied, a specific first action included in the plural first actions may be applied.

In the control program for the terminal device, the second object which is to perform the second action may be selected as a result of the first user specifying the second object in the displayed second image. In response to the first user selecting the second object which is to perform the second action, plural selection objects corresponding to the respective first actions may be displayed. The first action to be performed by the first object may be a first action corresponding to a selection object selected from the displayed selection objects by the first user.

In the control program for the terminal device, the second image including the second object which is to perform the second action may be selected as a result of the first user specifying the displayed second image. In response to the first user selecting the second image including the second object which is to perform the second action, plural selection objects corresponding to the respective first actions may be displayed. The first action to be performed by the first object may be a first action corresponding to a selection object selected from the displayed selection objects by the first user.

In the control program for the terminal device, the terminal device of the first user may be caused to execute: automatically displaying selection objects corresponding to the respective first actions within the second image during a first period starting from when the second image including the second object is displayed. The first action to be performed by the first object may be a first action corresponding to a selection object selected from the selection objects by the first user. The second object which is to perform the second action may be a second object displayed within the second image which includes the selection object selected by the first user.

In the control program for the terminal device, the second action that the second object performs may be a second action which is selected from multiple second actions by the second user on the terminal device of the second user during a second period starting from when an instruction to cause the first object to perform the first action is provided by the first user or starting from when the first object which performs the first action is displayed.

In the control program for the terminal device, the second action that the second object performs may be the second action which is related to the first action and which is automatically identified when the first action to be performed by the first object is selected by the first user.

In the control program for the terminal device, the terminal device of the first user may be caused to execute: receiving information indicating a third action, the third action being selected from multiple third actions by the second user on the terminal device of the second user during a third period starting from when the first object which performs the first action is displayed; and displaying the second object which performs the selected third action indicated by the received information after displaying the second object which performs the second action.

In the control program for the terminal device, in the displaying of the first object which performs the first action, the terminal device of the first user may be caused to execute: displaying, in response to an instruction from the first user or the second user, a selection screen for selecting one of plural specific actions; selecting, in response to an instruction from the first user, a specific action from the plural specific actions as the first action; and displaying the first object that performs the selected first action. In the displaying of the second object which performs the second action, the terminal device of the first user may be caused to execute: receiving, from the terminal device of the second user on which the selection screen is displayed, specific action information indicating a specific action selected from the plural specific actions by the second user as the second action; and displaying the second object that performs the selected second action indicated by the specific action information.

In the control program for the terminal device, the terminal device of the first user may be caused to execute: displaying, in response to an instruction from the first user or the second user, a selection screen for selecting one of plural specific actions; setting a specific action selected from the plural specific actions by the first user to be the first action; receiving, from the terminal device of the second user on which the selection screen is displayed, specific action information indicating a specific action selected from the plural specific actions by the second user as the second action; and setting the specific action indicated by the specific action information to be the second action. In the displaying of the first object that performs the first action and the second object that performs the second action, the terminal device of the first user may be caused to execute: displaying, if the first action and the second action are set during a fourth period starting from when the selection screen is displayed, the first object that performs the set first action and the second object that performs the set second action.

In the control program for the terminal device, in the displaying of the second object which performs the second action, the terminal device of the first user may be caused to execute: displaying, if a condition concerning the number of times the second object performs the second action is satisfied, the second object that performs a fourth action, which is different from the second action, in addition to or instead of execution of the second action, in accordance with the first action of the first object.

In the control program for the terminal device, in the displaying of the second object which performs the second action, the terminal device of the first user may be caused to execute: displaying, if a predetermined setting is set by the second user, the second object which does not perform the second action corresponding to the first action of the first object.

A control program for a server device according to the present disclosure is a control program for a server device which is able to communicate with a terminal device of a first user and a terminal device of a second user, the second user being different from the first user. The control program causes the server device to execute: receiving information concerning displaying of a first image from the terminal device of the first user, the first image including a first object indicating the first user, and receiving information concerning displaying of a second image from the terminal device of the second user, the second image including a second object indicating the second user; sending information for at least displaying the first image to at least the terminal device of the second user and sending information for at least displaying the second image to at least the terminal device of the first user; sending a first voice of the first user to the terminal device of the second user if the first voice of the first user is received; sending information for displaying the first image to at least the terminal device of the second user, the first image including the first object which is to be changed in accordance with an action or the first voice of the first user; sending a second voice of the second user to the terminal device of the first user if the second voice of the second user is received; sending information for displaying the second image to at least the terminal device of the first user, the second image including the second object which is to be changed in accordance with an action or the second voice of the second user; receiving information for displaying the first object which is changed in accordance with an instruction from the first user; and sending the information for displaying the changed first object to at least the terminal device of the second user.

A terminal device according to the present disclosure is a terminal device for a first user. The terminal device includes a processor which executes: displaying at least a first image and a second image, the first image including a first object indicating the first user, the second image including a second object indicating a second user, the second user being different from the first user; sending information concerning the displaying of the first image to a terminal device of the second user; sending a first voice of the first user to the terminal device of the second user if the first voice of the first user is obtained; displaying the first image including the first object which is to be changed in accordance with an action of the first user; outputting a second voice of the second user if the second voice of the second user is received; displaying the second image including the second object which is to be changed in accordance with an action of the second user; and displaying the first object which is changed in accordance with an instruction from the first user and also displaying the second image which is changed in accordance with the instruction from the first user.

A server device according to the present disclosure is a server device which is able to communicate with a terminal device of a first user and a terminal device of a second user, the second user being different from the first user. The server device includes a processor which executes: receiving information concerning displaying of a first image from the terminal device of the first user, the first image including a first object indicating the first user, and receiving information concerning displaying of a second image from the terminal device of the second user, the second image including a second object indicating the second user; sending information for at least displaying the first image to at least the terminal device of the second user and sending information for at least displaying the second image to at least the terminal device of the first user; sending a first voice of the first user to the terminal device of the second user if the first voice of the first user is received; sending information for displaying the first image to at least the terminal device of the second user, the first image including the first object which is to be changed in accordance with an action or the first voice of the first user; sending a second voice of the second user to the terminal device of the first user if the second voice of the second user is received; sending information for displaying the second image to at least the terminal device of the first user, the second image including the second object which is to be changed in accordance with an action or the second voice of the second user; receiving information for displaying the first object which is changed in accordance with an instruction from the first user; and sending the information for displaying the changed first object to at least the terminal device of the second user.

A control method for a terminal device according to the present disclosure is a control method for a terminal device of a first user. The control method includes: displaying at least a first image and a second image, the first image including a first object indicating the first user, the second image including a second object indicating a second user, the second user being different from the first user; sending information concerning the displaying of the first image to a terminal device of the second user; sending a first voice of the first user to the terminal device of the second user if the first voice of the first user is obtained; displaying the first image including the first object which is to be changed in accordance with an action or the first voice of the first user; outputting a second voice of the second user if the second voice of the second user is received; displaying the second image including the second object which is to be changed in accordance with an action or the second voice of the second user; and displaying the first object which is changed in accordance with an instruction from the first user and also displaying the second image which is changed in accordance with the instruction from the first user.

A control method for a server device according to the present disclosure is a control method for a server device which is able to communicate with a terminal device of a first user and a terminal device of a second user, the second user being different from the first user. The control method includes: receiving information concerning displaying of a first image from the terminal device of the first user, the first image including a first object indicating the first user, and receiving information concerning displaying of a second image from the terminal device of the second user, the second image including a second object indicating the second user; sending information for at least displaying the first image to at least the terminal device of the second user and sending information for at least displaying the second image to at least the terminal device of the first user; sending a first voice of the first user to the terminal device of the second user if the first voice of the first user is received; sending information for displaying the first image to at least the terminal device of the second user, the first image including the first object which is to be changed in accordance with an action or the first voice of the first user; sending a second voice of the second user to the terminal device of the first user if the second voice of the second user is received; sending information for displaying the second image to at least the terminal device of the first user, the second image including the second object which is to be changed in accordance with an action or the second voice of the second user; receiving information for displaying the first object which is changed in accordance with an instruction from the first user; and sending the information for displaying the changed first object to at least the terminal device of the second user.

A control program for a terminal device, a terminal device, a control method for a terminal device, a control program for a server device, a server device, and a control method for a server device according to the present disclosure make it possible to encourage a user to continue communicating with another user.

Various embodiments of the disclosure will be described below with reference to the accompanying drawings. It is noted, however, that the technical scope of the disclosure is not limited to these embodiments and is defined by the claims and their equivalents.

(Overview of Information System)

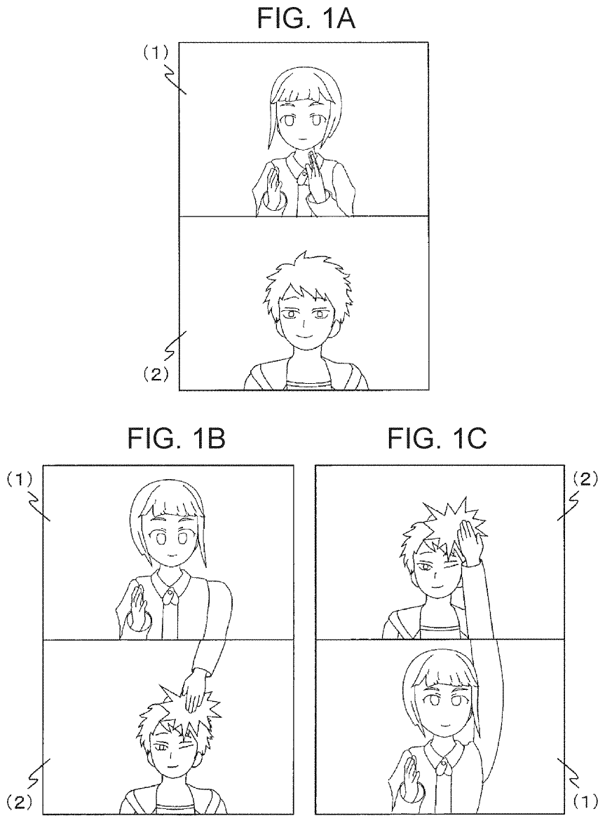

FIGS. 1A, 1B, and 1C are schematic views for explaining an example of an overview of an information system. The information system includes terminal devices individually operated by multiple users and a server device. The terminal device is, for example, an information processing device, such as a multifunction cellular phone (that is, a smartphone), of a user. The server device is, for example, a computer for providing a communication service, which is for the terminal devices to communicate with each other, via a communication network.

The terminal device stores a control program, such as an application program, and, in response to a start operation performed by a user, the terminal device loads the control program into a memory and executes instructions included in the loaded control program, thereby starting a communication service. For example, the terminal device may include a non-transitory computer readable medium storing computer executable instructions which, when executed by the terminal device, cause the terminal device to start the communication service. Likewise, the server device may include a non-transitory computer readable medium storing computer executable instructions which, when executed by the server device, cause the server device to start the communication service. After the communication service is started, the terminal device executes instructions included in the control program so as to implement multiple functions.

In one example, the terminal device of a user implements a generating function of generating output information. The output information includes character video data, such as motion data, based on various types of input data input by this user. The input data is, for example, plural items of imaging data obtained at predetermined sampling time intervals by an imaging unit installed in the terminal device. Each item of imaging data indicates an image of this user. The character video data is an example of information on the displaying of a user output image including a character object indicating the user. During the execution of the communication service, the output information is generated at predetermined time intervals.

In one example, the terminal device of a user implements an output function of sending output information to the server device at predetermined time intervals. The terminal device executes this function to display a user output image based on character video data and to send the resulting output information to the terminal device of another user via the server device. The terminal device of a user also implements a function of displaying an output image of another user including a character object of this user, based on output information of this user sent from the server device at predetermined time intervals.

After the communication service is started, as illustrated in FIG. 1A, a user output image (1) (hereinafter called a subject-user output image (1)) and an another-user output image (2) are displayed by the terminal device of a subject user. At the start of the communication service, if no user other than the subject user participates in the communication service, the subject-user output image (1) is only displayed by the terminal device of the subject user. At the start of the communication service, if the subject user does not participate in the communication service, the another-user output image (2) is only displayed in the terminal device of another user.

The subject-user output image (1) includes a character object of the subject user, which is moved in accordance with motion data of the subject user included in the character video data. The another-user output image (2) includes a character object of another user, which is moved in accordance with motion data of this user included in the received output information of this user. In this manner, the terminal device of the subject user displays the subject-user output image (1) including the character object of this user, which changes in accordance with the motion of this user, and also displays the another-user output image (2) including the character object of another user, which changes in accordance with the motion of this user.

The terminal device of the subject user and that of another user each have a microphone. The terminal device of the subject user thus obtains voice output from the subject user, while that of another user obtains voice output from this user. The terminal device of the subject user adds the obtained voice data of the subject user to the output information and sends the output information to the server device so that the output information can be sent to the terminal device of another user via the server device. The terminal device of the subject user also receives output information including voice data of another user, which is sent to the server device from the terminal device of this user.

For example, when voice is output from the subject user, face motion data indicating the movement of the user's lips is added to the motion data of the subject user, which is to be included in character video data. In this case, in the terminal device of the subject user, the subject-user output image (1) including the character object of the subject user which moves its lips substantially in synchronization with the voice generated from the user is displayed. In output information of a different user received by the terminal device of the subject user, voice data of the different user may be included, together with the motion data of this user. In this case, in the terminal device of the subject user, voice generated by the different user is output, and also, the another-user output image (2) including the character object of this user which moves its lips substantially in synchronization with the voice of this user is displayed.

In addition to the above-described functions, the terminal device of the subject user implements a function of making a change to the character object included in the subject-user output image (1) in response to an instruction from the user and displaying the resulting character object. The terminal device of the subject user may also implement a function of making a change to the another-user output image (2) in response to an instruction from the subject user and displaying the changed another-user output image (2).

For example, in response to an instruction to make a change to the character object from the subject user, the terminal device of the subject user makes a change to the character object, thereby changing the subject-user output image (1). For example, as illustrated in FIG. 1B, in response to an instruction from the subject user, the terminal device of the subject user makes the character object of the user extend its arm to the character object of another user. In this manner, the terminal device of the subject user automatically makes a change to the character object of the subject user. In the example in FIG. 1B, the terminal device of the subject user adds the hand and the arm of the character object extended from this character object to the another-user output image (2) so as to automatically change the another-user output image (2).

The terminal device of the subject user may cause the character object of the subject user to hit the character object of the different user within the another-user output image (2) with its extended hand. The terminal device of the subject user may also cause the character object of the different user to react to this hitting action. While the character object of the subject user is automatically changing in response to an instruction from the subject user (for example, during three seconds for which the character object extends the arm and pulls it back to the original position), the terminal device of the subject user may not necessarily make the character object perform an action in accordance with the motion data of the user. Likewise, while the another-user output image (2) is automatically changing in response to an instruction from the subject user (for example, for three seconds for which the arm appears, extends to the character object of the different user, and disappears), the terminal device of the different user may not necessarily make the character object perform an action in accordance with the motion data of this user.

An instruction to make a change to a character object (which may also be simply called an instruction) is input as a result of a user selecting one of predetermined operation objects (such as button objects), for example. An instruction may be input in accordance with the type of operation performed by the user selected from plural types of operations. The plural types of operations are each associated with one of multiple actions that the character object of the user can perform. Examples of the multiple actions that the character object of the user can perform are hitting the character object of another user, as illustrated in FIG. 1B, tickling the character object of another user, and stroking the character object of another user.

As illustrated in FIG. 1C, as in the terminal device of the subject user, the terminal device of the different user displays at least the another-user output image (2) and the subject-user output image (1). The another-user output image (2) includes the character object of the different user, which moves in accordance with the motion data included in the character video data of this user. The subject-user output image (1) includes the character object of the subject user, which moves in accordance with the motion data of the subject user included in the output information of this user sent from the terminal device of the subject user. In this manner, the terminal device of the different user displays the another-user output image (2) including the character object of this user, which changes in response to the movement of this user, and also displays the subject-user output image (1) including the character object of the subject user, which changes in response to the movement of this user.

When an instruction sent from the subject user to the server device is received by the terminal device of the different user via the server device, the another-user output image (2) is changed, and also, the character object of the subject user is changed, as in the case of FIG. 1B. In the example in FIG. 1C, the terminal device of the different user displays the subject-user output image (1) and the another-user output image (2) in the order different from that on the terminal device of the subject user. Alternatively, the terminal device of the different user may display the subject-user output image (1) and the another-user output image (2) in the same order as that on the terminal device of the subject user.

A change to be made to the character object of the subject user and that to the another-user output image (2) in response to an instruction from the subject user are not restricted to a change to be made by the movement of the character object. For example, a change to be made to the character object of the subject user may be a change of the color and/or the luminance of the character object or a change of the size of the character object. A change to be made to the another-user output image (2) may be a change of the color and/or the luminance of the another-user output image (2), a change of the size of the character object, or a change caused by adding new text, a new icon image, and/or a new mark image.

As discussed above with reference to FIGS. 1A through 1C, according to a control program for a user terminal device, a user terminal device, a control method for a user terminal device, a control program for a server device, a server device, and a control method for a server device according to an embodiment of the disclosure, a user character which changes in response to an instruction from a user and an another-user output image which changes in response to an instruction from the user are output. In this manner, according to a control program for a user terminal device, a user terminal device, a control method for a user terminal device, a control program for a server device, a server device, and a control method for a server device according to an embodiment of the disclosure, during the execution of a communication service, output from the terminal device of a user can be changed by this user. This can encourage the user to continue communicating with another user.

In a conventional information system, when a subject user communicates with another user via a character object, such as an avatar representing the subject user, motion data of the subject user is used to present the facial expressions and body gestures of the character object. To implement this, a terminal device is required to create animation of the character object in accordance with the successively generated motion data. This increases the load of drawing processing in the terminal device of the subject user, which may reduce the drawing speed. Additionally, to display animation of the character object of the subject user on a terminal device of a different user, the terminal device of the subject user sends its motion data to the terminal device of the different user via a server device. The terminal device of the subject user is thus required to send the successively generated motion data to the terminal device of the different user via the server device. This elevates the load of communication between the terminal device and the server device, which sometimes leads to degradation of sound and/or failures to properly perform drawing of the character object.

In contrast, according to a control program for a user terminal device, a user terminal device, a control method for a user terminal device, a control program for a server device, a server device, and a control method for a server device according to an embodiment of the disclosure, instead of generating animation of a character object of a user by successively obtaining the motion of the user, motion data of a character object, which is generated in advance, can be used to execute drawing processing and communication processing. It is thus possible to reduce the processing load on the terminal device and/or the communication load between the terminal device and the server device.

In a conventional information system, to change the facial expressions and body gestures of a character object of a user, the user actually makes his/her facial expressions and moves the body to generate motion data. After obtaining the user's facial expressions and body gestures, if the terminal device fails to generate motion data by reflecting the user's facial expressions and body gestures as the user has intended, the user is required to repeat the same facial expressions and body gestures. In this manner, in a conventional information system, it is not always easy to make a character object instantly and precisely act as a user has intended.

In contrast, according to a control program for a user terminal device, a user terminal device, a control method for a user terminal device, a control program for a server device, a server device, and a control method for a server device according to an embodiment of the disclosure, a user does not have to make a gesture to cause the character object to make this gesture, and instead, the user merely performs an operation for specifying the type of action, and then, instant and dynamic communication can be implemented, thereby improving the usability.

In a conventional information system, output images including a character object of a user are displayed merely in a display region set for this user, and it is not possible to display information on the user beyond the display region of this user. Even when the character object of the user is making some expression for a character object of another user, such an expression is restricted to within the display region of the user, which makes it difficult to convey what the user means by this expression.

In contrast, according to a control program for a user terminal device, a user terminal device, a control method for a user terminal device, a control program for a server device, a server device, and a control method for a server device according to an embodiment of the disclosure, character objects of users can interact with each other beyond each other's display regions. Even in a terminal device with a limited display area, expressive communication can be implemented.

In the example in FIGS. 1A through 1C, the subject user and the different user are users belonging to a certain communication group among multiple users that can access the communication service. The certain communication group is a group created by the subject user or the different user. In the example in FIGS. 1A through 1C, the character objects of the two users are shown, but character objects of three or more users belonging to this communication group may be displayed, so that these users can communicate with each other.

In the example in FIGS. 1A through 1C, the subject user and the different user may be users have a predetermined relationship. For example, the different user, who has a predetermined relationship with the subject user, is a mutual follower of the subject user. If the subject user follows the different user and the different user also follows the subject user, they are mutual followers. The different user, who has a predetermined relationship with the subject user, may be a mutual follower of a certain user who is a mutual follower of the subject user. The different user, who has a predetermined relationship with the subject user, may be a friend user of the subject user. The different user, who has a predetermined relationship with the subject user, may be a user whose specific information (such as a telephone number, email address, or preset identification (ID)) is stored in the terminal device of the subject user. If the terminal device of the subject user has a function of distributing a subject-user output image including the character object of the subject user to the terminal device of another user or the terminal devices of other users via the server device, the different user, who has a predetermined relationship with the subject user, is a user having viewed the subject-user output image. In this case, when the subject user and the different user perform communication, such as that shown in FIGS. 1A through 1C, a certain communication group including these users may temporarily be created by the terminal device of the subject user or the different user or by the server device.

The above-described explanation with reference to FIGS. 1A through 1C is provided merely for better understanding of the content of the disclosure. The disclosure is carried out through illustration of the following embodiments and may be carried out by various modified examples without departing from the spirt and scope of the disclosure. Such modified examples are all encompassed in the scope of the disclosure of the specification.

(Information System 1)

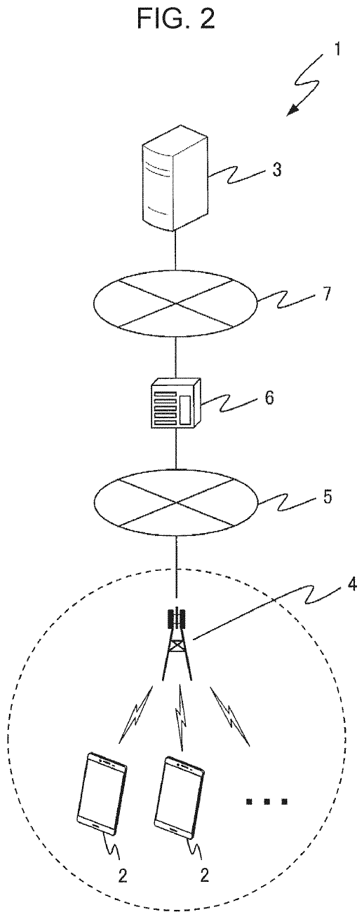

FIG. 2 illustrates an example of the schematic configuration of an information system 1. The information system 1 includes terminal devices 2 operated by individual users and a server device 3. The terminal devices 2 and the server device 3 are connected to each other via a base station 4, a mobile communication network 5, a gateway 6, and a communication network, such as the internet 7, for example. The terminal devices 2 and the server device 3 perform communication therebetween based on a communication protocol, such as a hypertext transfer protocol (HTTP). The terminal devices 2 and the server device 3 may first establish connection by HTTP communication and then perform communication based on WebSocket, which can perform duplex communication at a lower cost (lower communication load and processing load) than HTTP communication. The communication system between the terminal devices 2 and the server device 3 is not limited to the above-described system. Any communication system technology may be used between the terminal devices 2 and the server device 3 if it is able to carry out the embodiments. Hereinafter, the terminal devices 2 will collectively be called the terminal device 2 unless it is necessary to distinguish them from each other.

The terminal device 2 is an information processing device, such as a smartphone. The terminal device 2 may alternatively be another type of device, such as a cellular phone, a laptop personal computer (PC), a tablet terminal, a tablet PC, a head mounted display (HMD), an e-book reader, or a wearable computer. The terminal device 2 may be another type of device, such as a portable game machine or a game console. The terminal device 2 may be any type of information processing device if it is able to display a character object of a user operating the terminal device 2 and that of another user and to output voice data of these users.

In the example in FIG. 2, one server device 3 is shown as a component of the information system 1. However, the server device 3 may be a set of physically separate server devices 3. In this case, the server devices 3 may have the same function or have the different functions provided for a single server device 3 in a distributed manner.

(Terminal Device 2)

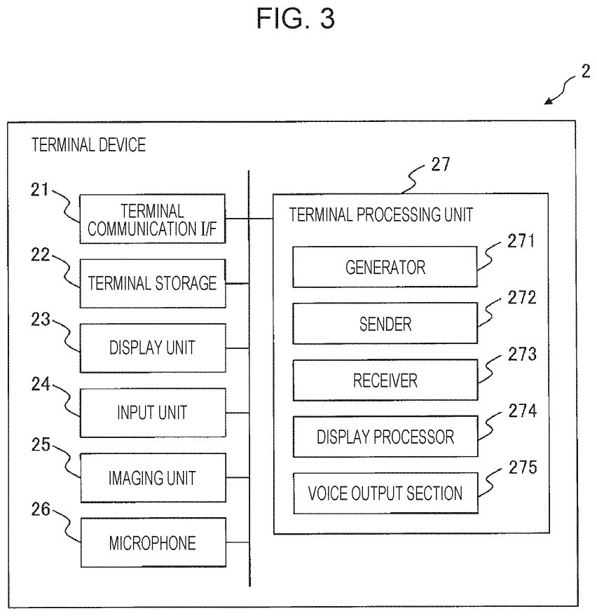

FIG. 3 illustrates an example of the schematic configuration of the terminal device 2. The terminal device 2 connects to the server device 3 via the base station 4, the mobile communication network 5, the gateway 6, and a communication network, such as the internet 7, and performs communication with the server device 3. The terminal device 2 generates character video data including motion data in accordance with various items of data (such as imaging data) input by a user, and sends output information including the generated character video data and/or user voice data to the server device 3. The terminal device 2 also receives output information of another user sent from the server device 3, and displays a character object of this user and/or outputs voice data of this user, based on the received output information. To implement these functions, the terminal device 2 includes a terminal communication interface (I/F) 21, a terminal storage 22, a display unit 23, an input unit 24, an imaging unit 25, a microphone 26, and a terminal processing unit 27.

The terminal communication I/F 21 is installed as hardware, firmware, communication software, such as a transmission control protocol/internet protocol (TCP/IP) driver or a point-to-point protocol (PPP) driver, or a combination thereof. Via the terminal communication I/F 21, the terminal device 2 can send data to another device, such as the server device 3, and receive data from another device.

The terminal storage 22 is a semiconductor memory device, such as a read only memory (ROM) and a random access memory (RAM). The terminal storage 22 stores an operating system program, driver programs, a control program, and data, for example, used by the terminal processing unit 27 to execute processing. The driver programs stored in the terminal storage 22 are an output device driver program for controlling the display unit 23 and an input device driver program for controlling the input unit 24, for example. The control program stored in the terminal storage 22 is an application program for implementing various functions concerning a communication service, for example. The control program may be a program sent from the server device 3 or another device.

An example of the data stored in the terminal storage 22 is identification information (user ID, for example) for uniquely identifying a user operating the terminal device 2. Another example of the data stored in the terminal storage 22 is background data and model data. The terminal storage 22 also stores a user table T1, an object table T2, and a group table T3. The terminal storage 22 may temporarily store data concerning predetermined processing.

The background data is asset data for constructing a virtual space in a user output image where a character object of a user is present. Examples of the background data are data for drawing the background of the virtual space, data for drawing various objects to be included in the user output image, and data for drawing various background objects other than the above-described background and objects to be displayed in the user output image. The background data may include object position information indicating the positions of various background objects in the virtual space.

The display unit 23 is a liquid crystal display. The display unit 23 may alternatively be another type of display, such as an organic electroluminescence (EL) display. The display unit 23 displays, on a display screen, video images based on video image data and/or still images based on still image data supplied from the terminal processing unit 27. The display unit 23 may not necessarily be a component of the terminal device 2. For example, the display unit 23 may be a display of an HMD that can communicate with the server device 3 or a projection display, such as a projection mapping display or a retinal projection display, that can communicate with the terminal device 2 via a wired or wireless medium.

The input unit 24 is a pointing device, such as a touchscreen. The input unit 24, which is a touchscreen, can detect various touch operations, such as tapping, double tapping, and dragging, performed by a user. The touchscreen may include a capacitive proximity sensor and be able to detect a contactless operation performed by a user. The input unit 24 may be input keys. By using the input unit 24, the user can input characters, numerical characters, and symbols, and also specify positions on the display screen of the display unit 23, for example. When the user performs a certain operation on the input unit 24, the input unit 24 generates a signal corresponding to this operation and supplies the generated signal to the terminal processing unit 27 as an instruction from the user.

The imaging unit 25 is a camera including an imaging optical system, an imaging element, and an image processor, for example. The imaging optical system is an optical lens, for example, and forms light from a subject into an image on the imaging plane of the imaging element. The imaging element is a charge coupled device (CCD) or a complementary metal oxide semiconductor (CMOS), for example, and outputs the image of the subject formed on the imaging plane. The image processor creates video image data in a predetermined file format at preset intervals from images sequentially generated by the imaging element and outputs the created video image data as imaging data. The image processor also creates still image data in a predetermined file format from images generated by the imaging element and outputs the created still image data as imaging data.

The microphone 26 is a voice collector which collects voice output from a user and converts it to voice data. The microphone 26, which is configured to obtain voice output from the user, converts the obtained data input into voice data and outputs it to the terminal processing unit 27.

The terminal processing unit 27 is a processor that loads the operating system program, the driver programs, and the control program stored in the terminal storage 22 into a memory and executes instructions included in the loaded programs. The terminal processing unit 27 is an electronic circuit, such as a central processing unit (CPU), a micro processing unit (MPU), a digital signal processor (DSP), a graphics processing unit (GPU), or a combination thereof. The terminal processing unit 27 may alternatively be implemented by an integrated circuit, such as an application specific integrated circuit (ASIC), a programmable logic device (PLD), a field programmable gate array (FPGA), or a micro controller unit (MCU). Although the terminal processing unit 27 is illustrated as a single component in FIG. 3, it may be a set of physically separate processors.

As a result of executing various instructions included in the control program, the terminal processing unit 27 functions as a generator 271, a sender 272, a receiver 273, a display processor 274, and a voice output section 275. The functions of the generator 271, sender 272, receiver 273, display processor 274, and voice output section 275 will be discussed later.

(Various Tables)

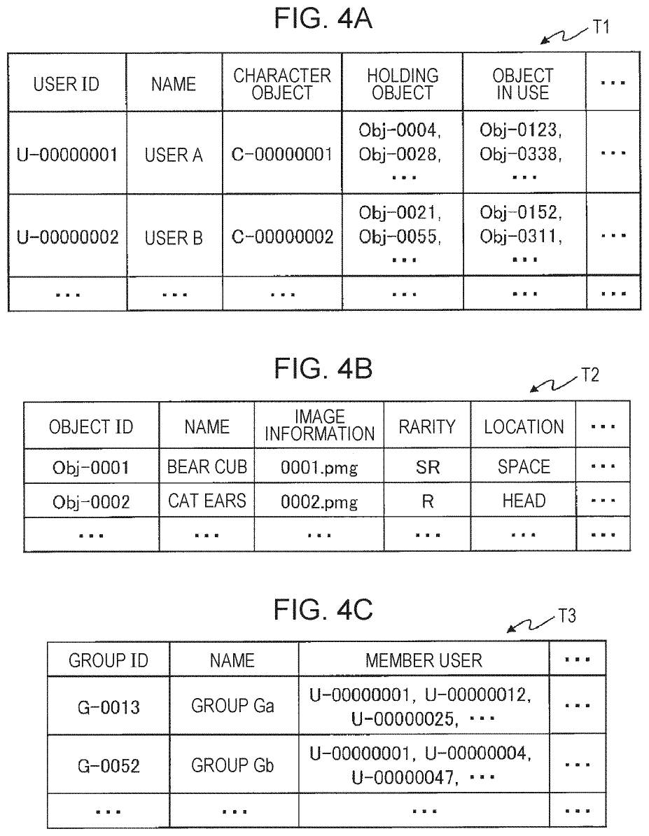

FIG. 4A illustrates an example of the data structure of a user table T1. FIG. 4B illustrates an example of the data structure of an object table T2. FIG. 4C illustrates an example of the data structure of a group table T3. The user table T1, the object table T2, and the group table T3 are all stored in the terminal storage 22. At least one of the user table T1, the object table T2, and the group table T3 may be stored in a server storage 32 of the server device 3. In this case, the terminal device 2 may receive the latest table stored in the server storage 32 at a predetermined timing and store it in the terminal storage 22.

(User Table T1)

FIG. 4A illustrates an example of the data structure of the user table T1 that manages users who participate in a communication service. In the user table T1, for each user, the user ID, name, character object, holding object, and object in use are stored in association with each other. Coin information (information on the total amount of “coin”, which is virtual money that the user holds) and/or point information, for example, may be stored in the user table T1 in association with the user ID. The user ID is an example of identification data for uniquely identifying the corresponding user. The name is an example of data indicating the name of the corresponding user.

The character object is a model ID for identifying model data for generating animation of a character object. The model data is stored in the terminal storage 22 in association with the model ID. The model data may be three-dimensional model data for generating three-dimensional animation or two-dimensional model data for generating two-dimensional model data. The model data includes rig data indicating the skeleton of the face and other parts of the character object (also called “skeleton data”) and surface data indicating the shape and the texture of the surface of the character object. The model data may include different items of model data. The plural items of model data may have different types of rig data or the same rig data. The plural items of model data may have different types of surface data or the same surface data.

The holding object is the object ID indicating an object held by each user. Examples of the holding object are an attach object and a wallpaper object. The attach object is an object which can be related to a specific part of the character object. The wallpaper object is an object placed at the back of the character object of the user in the user output image. Details of the attach object and the wallpaper object will be discussed later. As the holding object, an object selected by a user in a drawing game executed by the terminal device 2 of the user or the server device 3 is used. As the holding object, an object obtained as a result of a user consuming a coin, which is virtual money, by using a purchase function of the information system 1 may be used.

The object in use is the object ID indicating an object which is being used in the displayed user output image in the terminal device 2. In one example, during the execution of a communication service, in response to an instruction to make a change to a displayed user output image from a user, an attach object stored as a holding object of the user is worn on the character object of the user in the displayed user output image. In this case, the object ID of the attach object worn on the character object of the user is stored in the user table T1 as an object in use in association with the user ID. In another example, during the execution of a communication service, in response to an instruction to make a change to a displayed user output image from a user, a wallpaper object stored as a holding object of the user is placed at the back of the character object of the user in the displayed user output image. In this case, the object ID of the wallpaper object placed at the back of the character object of the user is stored in the user table T1 as an object in use in association with the user ID.

(Object Table T2)

FIG. 4B illustrates an example of the data structure of the object table T2 that manages an object to be selected as an add object. The add object is, for example, a gift object to be offered by a user to another user. In the object table T2, for each add object, the object ID, name, image information, rarity, and location are stored in association with each other.

The object ID is an example of identification data for uniquely identifying a corresponding add object. The image information is one or plural still images corresponding to each add object. The image information may be one or more video images corresponding to each add object. The rarity is information indicating the degree of rarity of each add object. The location is information indicating the location at which the image information of each add object is to be displayed. If the display position and the display range of a character object are fixed, information indicating the relative position of the add object to the character object may be stored as the location.

The add objects are classified as plural types (categories). Examples of the types of add objects are an effect object used as an effect gift, a regular object used as a regular gift, an attach object used as an attach gift, and a message object used as a message gift. A wallpaper object to be placed at the back of a character object within a user output image may be included as a type of add object. Information indicating the type (category) of add object may be stored in the object table T2 in association with the object ID of the add object. The image information and the location will be explained below in accordance with the type of add object.

The effect object is an object which produces an effect on the overall impression of a subject-user output image and/or an another-user output image. An example of the effect object is an object looking like confetti. In this case, as the image information, an image indicating multiple pieces of paper is stored.

As the location of the effect object, information indicating a space is stored. For example, the object looking like confetti is displayed in the entirety of the subject-user output image and/or the another-user output image. The effect object may be displayed on the entire screen (communication screen, which will be discussed later) including the subject-user output image and the another-user output image in response to an instruction from a user. The effect object may be displayed only on one of the subject-user output image and the another-user output image selected by the user. The effect object may be displayed to overlap the character object included in the subject-user output image and/or the another-user output image. The effect object is displayed by not relating to a specific part of a character object, unlike the attach object, which will be discussed later. In this manner, by displaying the effect object in response to an instruction from the user, the terminal device 2 of the information system 1 is able to change the overall impression of the subject-user output image and/or the another-user output image.

The regular object is an object looking like an stuffed animal, a bouquet, an accessory, or an object suitable as a gift or a present. As the location of the regular object, information indicating a space is stored. For example, information concerning a predetermined moving route is related to the regular object, and as the regular object, an object which moves along the predetermined moving route in the subject-user output image or the another-user output image is displayed. Information indicating a space to be stored as the location of the regular object may be classified as plural types. For example, the plural types of space are: a central space, which is the region at the center of the subject-user output image or the another-user output image when the output image is vertically divided into three regions; a left space, which is the region on the left side of the subject-user output image or the another-user output image when the output image is vertically divided into three regions; and a right space, which is the region on the right side of the subject-user output image or the another-user output image when the output image is vertically divided into three regions. The plural types of space may be: a central space, which is the region at the center of the subject-user output image or the another-user output image when the output image is horizontally divided into three regions; an upper space, which is the region on the upper side of the subject-user output image or the another-user output image when the output image is horizontally divided into three regions; and a lower space, which is the region on the lower side of the subject-user output image or the another-user output image when the output image is horizontally divided into three regions. In either of the two cases, the moving route related to the regular object is set within the type of space set as the location of the regular object. For example, if information indicating the right space is related to the regular object, information of the moving route which moves within the region on the right side among the above-described vertically divided three regions is related to the regular object. As the regular object, an object which moves in accordance with the predetermined moving route from the position, which is set for this regular object or which is set automatically and randomly, within the subject-user output image or the another-user output image may be displayed. The predetermined moving route is a route which makes the regular object drop in free fall, for example. The regular object may be displayed to overlap a character object. In this case, the regular object is displayed by not relating to a specific part of the character object, unlike the attach object, which will be discussed later. The regular object may be displayed so that it bounces off the character object.

When the regular object is displayed to overlap a character object, it may be displayed to overlap a portion other than the head part including the face of the character object. That is, the regular object is displayed so as not to overlap the head part of the character object. The regular object may be displayed to overlap a portion other than the upper body including the face. That is, the regular object is displayed not to overlap the upper body of the character object.

The attach object is an object which is related to a specific part (attachment part) of a character object and is displayed in the subject-user output image or the another-user output image. Examples of the specific part are portions of the head part of a character object, such as the front left side, front right side, rear left side, rear right side, front center, rear center, left eye, right eye, left ear, right ear, and entire hair. Other examples of the specific part are a thumb, ring finger, wrist, elbow, shoulder, upper arm, entire hand, and entire arm.

The attach object related to a specific part of a character object is displayed in the subject-user output image or the another-user output image so as to contact this specific part. The attach object related to a specific part of a character object may be displayed in the subject-user output image or the another-user output image so as to entirely or partially cover this specific part. The specific part may be identified by three-dimensional position information indicating the position in a three-dimensional coordinate space or may be related to position information of a three-dimensional coordinate space.

The image information of the attach object is information indicating the image of the attach object, for example, an accessory (such as a headband, a necklace, and earrings), clothes (such as a T-shirt and a dress), and a costume to be worn on the character object, and other objects that the character object can wear.

As the location of the attach object, information indicating the attachment part of a character object to which the attach object is related is stored. For example, if the attach object is a headband, information indicating the head of the character object is stored as the location of the attach object. If the attach object is a T-shirt, information indicating the torso of the character object is stored as the location of the attach object.

As the location of the attach object, information indicating plural attachment parts of a character object in a three-dimensional coordinate space may be stored. For example, if the attach object is a headband, the rear left side of the head and the rear right side of the head, which are two parts of the character object, may be stored as the location of the attach object. The attach object of a headband is thus displayed so as to be worn on both of the rear left side and the rear right side of the head of the character object.

When plural types of attach objects are to be worn on the same part of a character object, they are worn on the character object at different timings. This can avoid different types of attach objects from being worn on the same part of the character object at the same time. For example, if a headband as one type of attach object and a hat as another type of attach object are to be both worn on the head of the character object, they are not displayed on the head of the character object at the same time.

In the object table T2, the display period of the add object may be stored in association with the object ID of the add object. The display period may be varied according to the type of add object. For example, the display period of the attach object may be longer than that of the effect object and that of the regular object. If the display period of the attach object is sixty seconds, the display period of the effect object may be five seconds and that of the regular object may be ten seconds.

(Group Table T3)

FIG. 4C illustrates an example of the data structure of the group table T3 that manages a group to which a subject user belongs (such as a group including the subject user with friend users, a group including the subject user with his/her mutual follower users, and a group created by the subject user or another user). The group table T3 is set for each user, and the group table T3 shown in FIG. 4C is that of the user operating the terminal device 2 storing this group table T3.

In the group table T3, for each group, the group ID, name, and member user are stored in association with each other. The group ID is an example of identification data for uniquely identifying a corresponding group. The name is an example of data indicating the name of a corresponding group. The member user is the user ID of each user belonging to a corresponding group.

(Other Information)

The terminal storage 22 stores motion data on an action which is to be performed in accordance with an instruction to make a change to a character object. Details of motion data will be discussed later. For each action, the terminal storage 22 may store motion data associated with the action ID for identifying the corresponding action. Plural items of motion data may be associated with the action ID. In this case, the plural items of motion data may be individually associated with the relative positions on the display screen of a character object to be subjected to the action (hereinafter called a passive character object) with respect to a character object that performs this action (hereinafter called an active character object). Examples of information on the relative position of a passive character object to an active character object are that the passive character object is positioned on the left side adjacent to the active character object on the display screen, the passive character object is positioned next to and above the active character object on the display screen, and the passive character object is positioned next to and below another character object which is positioned next to and below the active character object on the display screen. Such motion data is used for generating animation which makes the active character object automatically move for a predetermined time (three seconds, for example). In the terminal storage 22, motion data for causing the passive character object of a user having received an instruction to react to the action for a predetermined time (such motion data will be called passive motion data) may be stored in association with the action ID.

Referring back to FIG. 3, the functions of the generator 271, the sender 272, the receiver 273, the display processor 274, and the voice output section 275 will be explained below.

(Generator 271)

The generator 271 obtains from the imaging unit 25 imaging data continuously output from the imaging unit 25. For example, the imaging unit 25 is installed at a position of the terminal device 2 such that, when the terminal device 2 is held by a user, the imaging unit 25 can image the face of the user looking at the display screen of the display unit 23. The imaging unit 25 continuously images the face of the user, generates imaging data of the face of the user, and outputs the imaging data to the generator 271 of the terminal processing unit 27. The imaging unit 25 may image a part of the user other than the face, such as the head, arm, hand (including fingers), chest, waist, legs, or another part, and generate imaging data. The imaging unit 25 may be a three-dimensional (3D) camera that can detect information in the depth direction of the face.

Based on the generated imaging data, the generator 271 generates face motion data, which digitally represents the motion of the face of the user, as required in accordance with the lapse of time. The face motion data may be generated at predetermined sampling time intervals. In this manner, the face motion data generated by the generator 271 can digitally represent the motion of the face of the user (a change in facial expressions) in chronological order.

The generator 271 may generate body motion data, which digitally represents the position and the orientation of some parts of the user (such as the head, arm, hand (including fingers), chest, waist, legs, or another part), together with or separately from the face motion data.

Body motion data may be generated based on detection information obtained from a known motion sensor worn by a user. In this case, the terminal communication I/F 21 of the terminal device 2 includes a predetermined communication circuit for obtaining detection information output from the motion sensor worn by the user by wireless communication. The generator 271 generates body motion data based on the detection information obtained by the terminal communication I/F 21. Body motion data may be generated at predetermined sampling time intervals. In this manner, the body motion data generated by the generator 271 can digitally represent the motion of the body of the user in chronological order.

Body motion data based on detection information from a motion sensor worn by a user may be generated in a shooting studio. In this case, a base station, a tracking sensor, and a display may be installed in the shooting studio. The base station is a multi-axis laser emitter, for example. As the motion sensor worn by the user, Vive Tracker made by HTC CORPORATION may be used. As the base station, the base station made by HTC CORPORATION may be used.

A supporter computer may be installed in a room next to the shooting studio. The display in the shooting studio may be able to display information received from the supporter computer. The server device 3 may be installed in the room where the supporter computer is placed. The room where the supporter computer is installed may be separated from the shooting studio with a glass window therebetween. In this case, an operator of the supporter computer can see the user in the shooting studio. The supporter computer may be able to change settings of various devices installed in the shooting studio in accordance with a user operation. For example, the supporter computer may be able to set the scanning interval of the base station, the settings of the tracking sensor, and various settings of various other devices. The operator may input a message into the supporter computer and this message may be displayed on the display in the shooting studio.

The generator 271 generates character video data including face motion data and/or body motion data generated as required and outputs the generated character video data to the display processor 274. Hereinafter, face motion data and body motion data may collectively be called motion data. The generator 271 also generates output information including the created character video data and the user ID stored in the terminal storage 22, and outputs the generated output information to the sender 272. If the generator 271 obtains voice data of the user output from the microphone 26, it generates output information including the created character video data, the obtained voice data, and the user ID stored in the terminal storage 22, and outputs the generated output information to the sender 272.

(Sender 272)

The sender 272 sends the output information received from the generator 271 to the server device 3 via the terminal communication I/F 21, together with destination information. The destination information indicates the user ID of another user or the user IDs of other users participating in the communication service with the user using the terminal device 2 (subject user). The user ID included in the output information may alternatively be used as the destination information. For example, the server device 3 stores the user ID of another user or the user IDs of other users participating in the communication service with the subject user. Upon receiving the output information, the server device 3 specifies the user ID of another user or the user IDs of other users participating in the communication service with the subject user whose user ID is included in the output information, and sends the output information to the terminal device 2 of the user indicated by the specified user ID or the terminal devices 2 of the users indicated by the specified user IDs.

The sender 272 also sends information indicating various instructions input as a result of the subject user operating the input unit 24 to the server device 3 via the terminal communication I/F 21, together with the user ID stored in the terminal storage 22 and the destination information. Various instructions input by the subject user include an instruction to make a change to the character object of the subject user and to an another-user output image. Such an instruction is sent to the server device 3 via the terminal communication I/F 21, together with content-of-change identification information for identifying the content of change (action ID, for example), the user ID of a user whose another-user output image is to be changed, and the user ID of the subject user having provided the instruction. The instruction may be sent together with information indicating the relative position of a passive character object on the display screen with respect to an active character object.

(Receiver 273)

The receiver 273 receives, via the terminal communication I/F 21, information, such as output information of another user and information on various instructions from another user, sent from the server device 3. The receiver 273 outputs the received information to the terminal processing unit 27. The output information of another user sent from the server device 3 is information generated by the generator 271 of the terminal device 2 of this user and sent from the sender 272 of the terminal device 2 of this user to the server device 3. The output information of another user includes character video data of this user, voice data of this user, and the user ID of this user. The output information of another user may not necessarily include voice data of this user. The output information of another user may not necessarily include character video data of this user.

(Display Processor 274)

The display processor 274 displays an image, which is drawn based on motion data (character video data) generated by the generator 271, on the display unit 23 as a subject-user output image. The display processor 274 also displays an image, which is drawn based on motion data (character video data) included in output information of another user received by the receiver 273, on the display unit 23 as an another-user output image. Drawing processing of an image based on motion data will be discussed below. In drawing processing of an image based on motion data of the subject user (who is the user operating the terminal device 2), the user ID stored in the terminal storage 22 is used. In drawing processing of an image based on motion data included in output information of another user received by the receiver 273, the user ID included in the output information is used.

The display processor 274 first extracts the model ID of the character object associated with the user ID and also extracts the object IDs of the objects in use from the user table T1. Then, the display processor 274 reads the model data associated with the extracted model ID and the image information and the location associated with each of the extracted object IDs of the objects in use from the terminal storage 22. Then, based on the read model data, the image information and the locations of the objects in use, and the motion data, the display processor 274 creates animation of a character object in which the objects in use are attached to the portions indicated by the locations. If face motion data is included in the motion data, the display processor 274 creates animation of the character object so that the facial expression of the character object changes based on the face motion data. In this manner, the display processor 274 can generate animation of the character object which moves in synchronization with the facial expression movement of the user, based on the read model data and face motion data. If face motion data and body motion data are included in the motion data, the display processor 274 generates animation of the character object which moves in synchronization with the facial expression movement and the body movement of the user, based on the read model data, face motion data, and body motion data.

The display processor 274 then draws an image including the generated animation of the character object (video image) and a background image representing a background generated by using background data stored in the terminal storage 22. The display processor 274 may use, as the background image, a wallpaper object which is stored in the terminal storage 22 in association with the communication group. In this case, the same wallpaper object may be used as the background image for all the users in the communication group. The display processor 274 then outputs drawing data indicating the drawn image and finishes drawing processing for the image based on the motion data. The image which is drawn based on the character object associated with the user ID stored in the terminal storage 22 is the subject-user output image of this user. The image which is drawn based on the character object associated with the user ID included in the received output information of another user is the another-user output image of this user.

The display processor 274 may also display on the display unit 23 a character object of the subject user which automatically moves in response to an instruction from the subject user and an another-user output image which automatically changes in response to the instruction from the subject user. For example, if the instruction from the subject user is to cause its character object to hit another user, the display processor 274 first determines the display positions of the character object of the subject user and the character object of the other user. The character object of the other user to be hit by that of the subject user is the character object specified by the subject user.

The display processor 274 extracts motion data stored in the terminal storage 22, based on the content of a change (hitting) indicated by the instruction from the subject user and the display positions of the character object of the subject user and that of the other user. Then, based on the extracted motion data, the display processor 274 generates animation representing that the character object of the subject user extends the arm toward the character object of the other user and then returns it to the original position. The display processor 274 then generates a subject-user output image including the generated animation and a background image. The animation is automatically displayed for a predetermined time (three seconds, for example) by using prestored motion data instead of the motion data of the subject user generated by the generator 271. When generating the animation of the character object of the subject user in response to an instruction from the subject user, the display processor 274 may also use part of the motion data of the subject user generated by the generator 271. For example, if the instruction from the subject user indicates the action using the arm of the character object, face motion data may also be used. With this operation, in the information system 1, the character object of the subject user can make a variety of expressions, as well as simply making a certain motion in response to an instruction from the subject user. This can encourage users to continue communicating with each other.

Then, the display processor 274 generates animation representing that the arm of the character object of the subject user extends toward the character object of the other user, hits the character object of the other user, returns to its original position, and disappears. The display processor 274 then generates an another-user output image including the generated animation and a background image. The animation is automatically displayed for a predetermined time (three seconds, for example) by using prestored passive motion data instead of the motion data of the other user generated by the terminal device 2 of this user. As in the generating of the animation of the character object of the subject user, when generating the animation of the character object of the other user in response to an instruction from the subject user, the display processor 274 may use part of the passive motion data of the other user generated by the terminal device 2 of this user. For example, when the character object of the other user changes (reacts) in response to an instruction from the subject user, face motion data of the other user generated by the terminal device 2 of this user may also be used. With this operation, in the information system 1, the character object of the other user can make a variety of expressions, as well as simply making a certain motion in response to an instruction from the subject user. This can encourage users to continue communicating with each other.

The display processor 274 then displays the generated subject-user output image and another-user output image on the display unit 23.

In response to an instruction to add an add object from another user, the display processor 274 displays a subject-user output image including this add object. In response to an instruction to display an add object on an another-user subject image from the subject user, the display processor 274 displays the another-user output image including this add object.

If the object ID included in an instruction to add an add object from another user is that of an effect object, the display processor 274 refers to the object table T2, extracts from the terminal storage 22 a still image or a video image (image information) of the effect object associated with the object ID included in the instruction, and generates a subject-user output image including the extracted still image or video image. For example, if an instruction to add an effect object indicating confetti or a firework is provided, the display processor 274 generates a subject-user output image including a video image of an effect object looking like confetti or a firework. Likewise, if the object ID included in an instruction to add an add object from the subject user is that of an effect object, the display processor 274 refers to the object table T2, extracts from the terminal storage 22 a still image or a video image (image information) of the effect object associated with the object ID included in the instruction, and generates an another-user output image including the extracted still image or video image.

If the object ID included in an instruction to add an add object from another user is that of a regular object, the display processor 274 refers to the object table T2, extracts a still image or a video image (image information) and the location of the regular object associated with the object ID of the regular object. The display processor 274 then generates a subject-user output image including the extracted still image or video image disposed at the position indicated by the location. Likewise, if the object ID included in an instruction to add an add object from the subject user is that of a regular object, the display processor 274 refers to the object table T2, extracts a still image or a video image (image information) and the location of the regular object associated with the object ID of the regular object, and generates an another-user output image including the extracted still image or video image disposed at the position indicated by the location.

The display processor 274 may generate a subject-user output image and an another-user output image including a video image of a regular object which moves within the display regions of the subject-user output image and the another-user output image.

Hereinafter, a subject-user output image and an another-user output image may collectively be called an output image. In one example, the display processor 274 may generate an output image including a video image of a regular object which drops from the top to the bottom of the output image. In this case, the regular object may be displayed within the display region of the output image for the period from when it starts to drop until it reaches the bottom side of the output image, and then disappear from the output image. Examples of the moving route of the regular object in the output image are the left-to-right direction, right-to-left direction, from the top-left to the bottom-left direction, and other directions. Other examples of the moving route of the regular object are routes along a straight-line path, a circular path, an elliptical path, a spiral path, and other paths.

If the object ID included in an instruction to add an add object from another user is that of an attach object, the display processor 274 displays information on the instruction to add an attach object within the subject-user output image. In accordance with the instruction, the display processor 274 refers to the object table T2 and extracts the image information and the location of the attach object associated with the object ID included in the instruction. Based on the extracted image information and location, the display processor 274 generates a subject-user output image including a character object wearing the attach object on the part of the character object indicated by the location.

(Voice Output Section 275)

If voice data is included in output information of another user, the voice output section 275 outputs the voice of this user generated from the voice data from a speaker while an another-user output image is being displayed by the display processor 274. Then, while the lips of the character object of this user included in the another-user output image are moving, the voice of this user is output. This makes the subject user feel like as if the character object of the other user were speaking.

(Server Device 3)

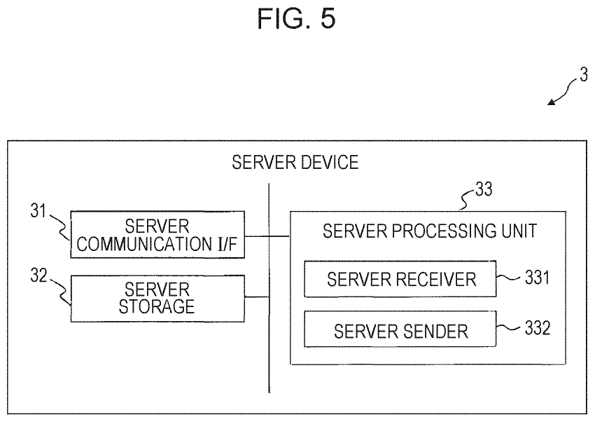

FIG. 5 illustrates an example of the schematic configuration of the server device 3. The server device 3 provides a communication service to the terminal devices 2 of individual users. The server device 3 sends output information and information on various instructions received from the terminal device 2 of one user to the terminal device 2 of another user. To implement this function, the server device 3 includes a server communication I/F 31, a server storage 32, and a server processing unit 33. The terminal device 2, which is a device to receive information sent from the terminal device 2 of one user, is the terminal device 2 of the user indicated by the user ID included in destination information received together with the information.

The server communication I/F 31 is installed as hardware, firmware, communication software, such as a TCP/IP driver or a PPP driver, or a combination thereof. Via the server communication I/F 31, the server device 3 can send information to another device and receive information from another device.

The server storage 32 is a semiconductor memory device, such as a ROM and a RAM. The server storage 32 may be a magnetic disk, an optical disc, or another type of storage device that can store data. The server storage 32 stores an operating system program, driver programs, a control program, and data, for example, used by the server processing unit 33 to execute processing. The server storage 32 may store the user table T1, the object table T2, and the group table T3 as the data.

The server processing unit 33 is a processor that loads the operating system program, the driver programs, and the control program stored in the server storage 32 into a memory and executes instructions included in the loaded programs. The server processing unit 33 is an electronic circuit, such as a CPU, an MPU, a DSP, or a GPU, or a combination thereof. The server processing unit 33 may alternatively be implemented by an integrated circuit, such as an ASIC, a PLD, an FPGA, or an MCU. Although the server processing unit 33 is illustrated as a single component in FIG. 5, it may be a set of physically separate processors. As a result of executing various instructions included in the control program, the server processing unit 33 functions as a server receiver 331 and a server sender 332.

(Server Receiver 331)

The server receiver 331 receives, via the server communication I/F 31, various items of information, such as output information and information on various instructions, sent from the terminal device 2 of a user. The server receiver 331 may receive destination information, together with output information and information on various instructions sent from the terminal device 2.

(Server Sender 332)

The server sender 332 sends, via the server communication I/F 31, output information and information on various instructions received from one user by the server receiver 331 to the terminal device 2 of another user indicated by the user ID included in destination information, which is received together with the output information. The server sender 332 may send, via the server communication I/F 31, information on various instructions received from one user by the server receiver 331 to the terminal device 2 of another user or the terminal devices 2 of other users specified by the user having sent the information.

(Examples of Various Screens)

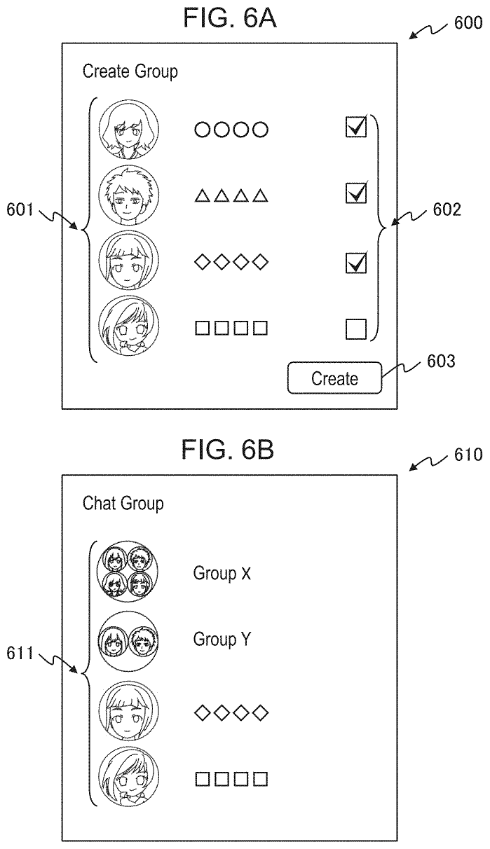

Examples of various screens displayed on the display unit 23 of the terminal device 2 of a user will now be explained below with reference to FIGS. 6A through 15B. In FIGS. 6A through 15B, plural elements designated by the same reference numeral are elements having equivalent functions.

FIG. 6A illustrates an example of a group creation screen 600 displayed on the display unit 23 of the terminal device 2 of a subject user. The group creation screen 600 includes an another-user display region 601, selection objects 602, and a create button 603. For example, the group creation screen 600 is displayed as a result of the subject user operating the input unit 24 and selecting a group creation object of a home screen which is displayed by the execution of the control program stored in the terminal storage 22.

In the another-user display region 601, another-user information on another user having a predetermined relationship with the subject user is displayed. In the example in FIG. 6A, the display processor 274 of the terminal device 2 of the subject user displays a thumbnail image of the character object of another user and the name of this user as the another-user information.

Each selection object 602 is an operation object for selecting the corresponding user indicated by the associated another-user information. In the example in FIG. 6A, the display processor 274 of the terminal device 2 of the subject user displays a check box object corresponding to each item of another-user information as the selection object 602. For example, when the subject user selects a certain selection object 602 by operating the input unit 24, the selection object 602 is displayed with a check mark. This means that the user indicated by the another-user information corresponding to this checked selection object 602 is being selected. When the selection object 602 displayed with a check mark is reselected by the subject user operating the input unit 24, the check mark is taken off. This means that the user indicated by the another-user information corresponding to this unchecked selection object 602 is not being selected. Each selection object 602 is associated with the user ID of the user indicated by the corresponding another-user information.

The create button 603 is a button object, for example, for the subject user to create a new communication group. When the subject user selects the create button 603 by operating the input unit 24, a new group including this user and other users selected with the selection objects 602 as member users is created. For example, the display processor 274 of the terminal device 2 of the subject user identifies the user ID of the subject user stored in the terminal storage 22 and the user IDs of the other users associated with the selected selection objects 602. The display processor 274 then relates the user ID of the subject user and the user IDs of the other users with a newly created group ID as the member users and stores them in the group table T3. The display processor 274 may provide an automatically created group name or a name input by the subject user to the group ID.

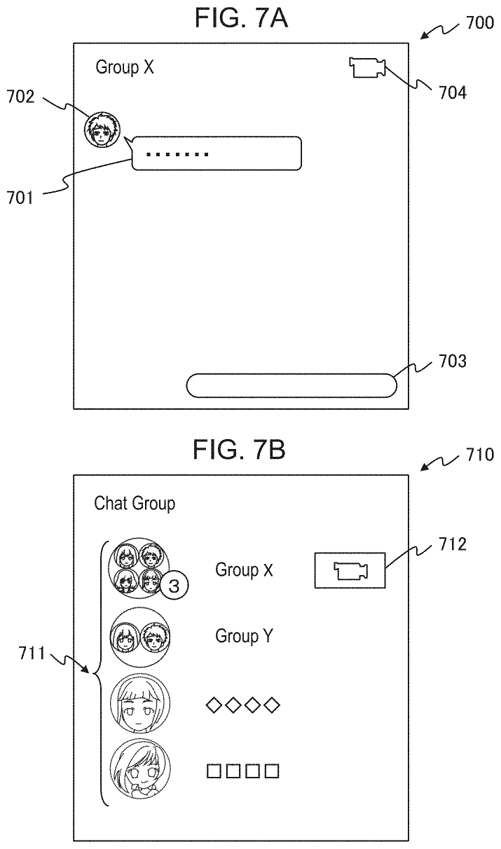

When a new group is created as a result of the subject user selecting the create button 603, the display processor 274 displays an information exchange screen 700 for the member users of the new group. FIG. 7A illustrates an example of the information exchange screen 700 displayed on the display unit 23 of the terminal device 2 of the subject user. The information exchange screen 700 includes a display region 701 in which information, such as text or an image, input by a certain member user is displayed, information 702 of a member user (a thumbnail image of the character object) having input information in the display region 701, an input object 703 for the subject user to input text or an image to be displayed in a new display region 701, and a start object 704 for starting a communication service.

When the information exchange screen 700 is displayed, the sender 272 of the terminal device 2 of the subject user sends, via the terminal communication I/F 21, an instruction to display the information exchange screen 700 to the server device 3, together with information on the new group and destination information. The information on the new group indicates the group ID, group name, and user ID of each member user of the new group. The destination information indicates the user IDs of the member users other than the subject user. The server receiver 331 of the server device 3 receives the instruction to display the information exchange screen 700, information on the new group, and destination information via the server communication I/F 31. The server receiver 331 may store the received destination information in the server storage 32. The server sender 332 of the server device 3 sends, via the server communication I/F 31, the instruction to display the information exchange screen 700 and information on the new group to the terminal devices 2 of the other users represented by the user IDs included in the destination information. Upon receiving the instruction to display the information exchange screen 700 sent from the terminal device 2 of the subject user via the server device 3, the terminal device 2 of another user can display the information exchange screen 700 through which the user can exchange information with other member users of the new group.

Referring back to FIG. 7A, when new information is input into the input object 703 by one of the member users, a display region 701 for displaying this information is added to the information exchange screen 700 on the terminal device 2 of this user. The sender 272 of the terminal device 2 of this user sends the input information to the terminal devices 2 of the member users other than this user via the server device 3. Then, the display region 701 for displaying this information is also added to the information exchange screen 700 on the terminal devices 2 of the other member users.

The start object 704 is a button object, for example, for starting a communication service in which each of the member users of the new group can participate. When a user selects the start object 704 by operating the input unit 24, start processing for a communication service using a group which can exchange information on the information exchange screen 700 as a communication group is executed. An example of start processing to be executed in response to a user (subject user) selecting the start object 704 will be discussed below.

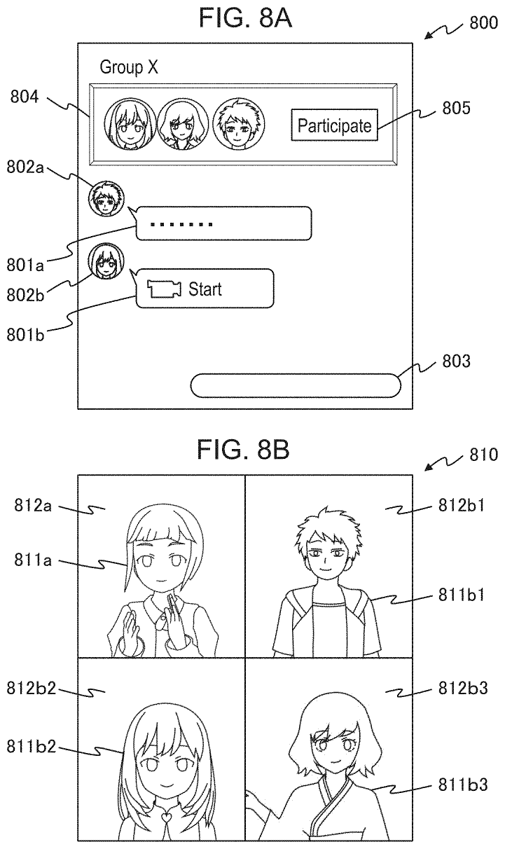

The display processor 274 of the terminal device 2 of the subject user first displays a communication screen 810 (see FIG. 8B) that can be displayed by the terminal device 2 of each member user of the communication group. The display processor 274 also stores the group ID of the communication group in the terminal storage 22 as the group ID of the group having started the communication service. The display processor 274 also stores the user ID of the subject user in the terminal storage 22 as the user ID of a user participating in the communication service. If not all the other member users in the communication group participate in the communication service, only user output information of a user who has not participated in the communication service is displayed on the communication screen 810.

Then, the sender 272 of the terminal device 2 of the subject user sends, via the terminal communication I/F 21, an instruction to start the communication service to the server device 3, together with the user ID of the subject user stored in the terminal storage 22 and information on the communication group and/or destination information. The information on the communication group indicates the group ID, group name, and user ID of each member user of the communication group. The destination information indicates the user IDs of the member users other than the subject user. If the destination information is stored in the server storage 32, it may not necessarily be sent to the server device 3. The server receiver 331 of the server device 3 receives, via the server communication I/F 31, the instruction to start the communication service, user ID, and information on the communication group and/or destination information. The server sender 332 of the server device 3 sends, via the server communication I/F 31, the instruction to start the communication service, user ID, and information on the communication group to the terminal devices 2 of the other member users represented by the user IDs included in the destination information.

The receiver 273 of the terminal device 2 of another member user receives the instruction to start the communication service, user ID, and information on the communication group sent from the server device 3. The receiver 273 stores the group ID indicated by the information on the communication group in the terminal storage 22 as the group ID of the group having started the communication service. The display processor 274 stores the received user ID in the terminal storage 22 as the user ID of a user participating in the communication service. The display processor 274 displays a notification screen, based on the received information on the communication group. The display processor 274 displays on the display unit 23 a group selection screen 710 (see FIG. 7B), which is a screen for a member user to participate in the communication service by selecting a predetermined object on the notification screen. The start processing is then completed. The display processor 274 may include a participate button 805, which will be discussed later, in the notification screen. This enables the user to participate in the communication service right away without the display processor 274 displaying the group selection screen 710.

The start processing may be executed as a result of a user selecting the create button 603 on the group creation screen 600 by operating the input unit 24. That is, in response to a user selecting the create button 603, start processing for starting a communication service using a new group created on the group creation screen 600 as a communication group may be executed. In this case, the information exchange screen 700 is not displayed.

The start processing is not restricted to that for starting a communication service using a new group created on the group creation screen 600 as a communication group. For example, start processing for starting a communication service using an already created group as a communication group may be executed. FIG. 6B illustrates an example of a group selection screen 610 for selecting a communication group created by a user. For example, the group selection screen 610 is displayed when a user operates the input unit 24 and selects a group selection object, for example, on the home screen displayed in response to the execution of the control program stored in the terminal storage 22.

The group selection screen 610 displayed on the terminal device 2 of the subject user includes a group display region 611 for selecting one of the multiple communication groups. In the group display region 611, group information on each of the already created communication groups to which this user belongs is displayed. In the example in FIG. 6B, the display processor 274 of the terminal device 2 of this user displays thumbnail images of the individual member users of a group and the name of the group as the group information. Although the thumbnail images of other member users are displayed in the example in FIG. 6B, the thumbnail images of all the member users may be displayed. If a communication group has only one member user except for the subject user, the name of this member user may be displayed instead of the name of the group, as shown in FIG. 6B.

When the subject user selects one item of group information in the group display region 611 by operating the input unit 24, the information exchange screen 700 to be used by the member users of the communication group corresponding to the selected item of group information is displayed. On the information exchange screen 700, information, such as text or an image input by a member user of the communication group is displayed. An instruction to display the information exchange screen 700 and information on the communication group are sent to the terminal devices 2 of the other member users via the server device 3, and the information exchange screen 700 is displayed on the terminal devices 2 of the other member users.

When the subject user selects the start object 704 on the information exchange screen 700, start processing for starting the communication service to be used by the communication group to exchange information on the information exchange screen 700 is executed. Then, the display processor 274 of the terminal device 2 of the subject user displays the communication screen 810 (see FIG. 8B) that can be displayed by the terminal device 2 of each member user. The display processor 274 of the terminal device 2 of another member user displays a notification screen. In accordance with an operation of the member user on the notification screen, the display processor 274 displays on the display unit 23 the group selection screen 710 (see FIG. 7B) for this member user to participate in the communication service. The display processor 274 may add the participate button 805, which will be explained later, to the notification screen.

The start processing may be executed as a result of the subject user selecting one item of group information on the group selection screen 610 by operating the input unit 24. That is, in response to the user selecting one item of group information, start processing for starting a communication service using the communication group corresponding to the selected item of group information may be executed. In this case, the information exchange screen 700 is not displayed.

A description will now be given of how to participate in an already started communication service by a user. FIG. 7B illustrates an example of the group selection screen 710 displayed on the display unit 23 of the terminal device 2 of a user. The group selection screen 710 is displayed as a result of the user selecting a predetermined object on a displayed notification screen, for example. The group selection screen 710 may alternatively be displayed as a result of the user operating the input unit 24 and selecting a group selection object, for example, on the home screen displayed in response to the execution of the control program stored in the terminal storage 22.

In a group display region 711 of the group selection screen 710, group information on a communication group which has already started a communication service is displayed such that it can be distinguished from other group information. In the example in FIG. 7B, the group information displayed on the topmost side of the group display region 711 indicates a communication group which has already started a communication service. For example, information indicating the number of member users participating in the communication service is displayed on or near the thumbnail image of the member users of the communication group. A mark image 712 indicating the communication service is also displayed near the name of the communication group.

The user operates the input unit 24 and selects an item of group information indicating the communication group which has started a communication service among plural items of group information in the group display region 711. Then, an information exchange screen 800 to be used by member users of the communication group corresponding to the selected item of group information is displayed.

FIG. 8A illustrates an example of the information exchange screen 800 displayed on the display unit 23 of the terminal device 2 of the user (this user will be called the subject user). The information exchange screen 800 includes display regions 801a and 801b, items of information 802a and 802b, an input object 803, a service display region 804, and a participate button 805. In each of the display regions 801a and 801b, information, such as text or an image, input by a certain member user of the communication group which has started a communication service is displayed. The items of information 802a and 802b indicate member users (thumbnail images of the character objects) having input information in the display regions 801a and 801b, respectively. The input object 803 is displayed for the subject user to input text or an image to be displayed in a new display region 801. The service display region 804 indicates an already started communication service. The participate button 805 is used for participating in the already started communication service.

In the service display region 804 shown in FIG. 8A, the thumbnail images of character objects of three member users participating in the communication service are displayed. In the display region 801b shown in FIG. 8A, information indicating that the communication service is started is displayed. In response to the subject user selecting the participate button 805, participation processing is executed. An example of participation processing will be discussed below.

In response to the subject user selecting the participate button 805, the display processor 274 of the terminal device 2 of the subject user first stores, in the terminal storage 22, the user ID of the subject user stored in the terminal storage 22 as the user ID of a member user participating in the communication service indicated in the service display region 804. The display processor 274 then displays the communication screen 810 (see FIG. 8B) including user output images of all the member users participating in the communication service.

Then, the sender 272 of the terminal device 2 of the subject user sends, via the terminal communication I/F 21, an instruction to participate in the communication service to the server device 3, together with the user ID of the subject user stored in the terminal storage 22 and information on the communication group and/or destination information. The information on the communication group indicates the group ID, group name, and user ID of each member user of the communication group. The destination information indicates the user IDs of the member users other than the subject user. The server receiver 331 of the server device 3 receives, via the server communication I/F 31, the instruction to participate in the communication service, user ID, and information on the communication group and/or destination information. The server sender 332 of the server device 3 sends, via the server communication I/F 31, the instruction to participate in the communication service, user ID of the subject user, and information on the communication group to the terminal devices 2 of the other member users represented by the user IDs included in the destination information.

The receiver 273 of the terminal device 2 of a member user receives from the server device 3 the instruction to participate in the communication service, user ID, and information on the communication group sent from the terminal device 2 of the subject user. The receiver 273 stores the received user ID in the terminal storage 22 as the user ID of a user participating in the communication service. If the communication screen 810 is displayed on the terminal device 2 of this user, the display processor 274 displays the updated communication screen 810 including the user output images of all the users participating in the communication service. The participation processing is then completed.

The participation processing may be executed in response to a user selecting one item of group information on the group selection screen 710 by operating the input unit 24. That is, in response to the user selecting one item of group information on the group selection screen 710, participation processing for letting the user participate in a communication service in which the communication group corresponding to the selected item of group information can participate may be executed. In this case, the information exchange screen 800 is not displayed.

The mode of start processing or participation processing for a communication service is not restricted to the above-described example. In the above-described example, start processing is executed in response to a user selecting the start object 704. However, start processing may be executed in a different manner. For example, start processing may be executed in response to a user selecting a predetermined display object for starting a communication service on a predetermined screen, such as a home screen. The predetermined display object may be displayed when a thumbnail image of a character object of the user is selected or may be included in a menu item of a predetermined screen. Start processing may automatically be executed when a predetermined start condition is satisfied. Examples of the predetermined start condition are that the current time has reached a preset time, a predetermined time has elapsed from the end of the previous time of a communication service, and the number of mutual followers of a subject user has exceeded a predetermined number. An example of such start processing will be described below as different start processing.

The sender 272 of the terminal device 2 of the subject user sends, via the terminal communication I/F 21, an instruction to start a communication service to the server device 3, together with the user ID of the subject user stored in the terminal storage 22 and/or destination information. The sender 272 also stores the user ID of the subject user in the terminal storage 22 as the user ID of a user participating in the communication service. The destination information indicates the user ID of a user or the user IDs of users having a predetermined relationship with the subject user. For example, the destination information may indicate the user ID of a mutual follower or the user IDs of mutual followers of the subject user. Instead of or in addition to the user ID of a mutual follower or the user IDs of mutual followers of the subject user, the destination information may indicate the user ID of a mutual follower or the user IDs of mutual followers of a predetermined user, who is a mutual follower of the subject user.

The server receiver 331 of the server device 3 receives, via the server communication I/F 31, the instruction to start the communication service, and user ID of the subject user, and/or destination information. The server sender 332 of the server device 3 sends, via the server communication I/F 31, the instruction to start the communication service, user ID, and destination information to the terminal device 2 of the user represented by the user ID or to the terminal devices 2 of the users represented by the user IDs included in the destination information. The receiver 273 of the terminal device 2 of a user receives from the server device 3 the instruction to start the communication service, user ID, and destination information sent from the terminal device 2 of the subject user. The receiver 273 stores the received user ID in the terminal storage 22 as the user ID of a user participating in the communication service. The display processor 274 displays a notification screen on the display unit 23, based on the received user ID. The notification screen includes information indicating an invitation from the subject user of the received user ID and a participate button, for example.

In response to the user selecting the participate button on the notification screen by operating the input unit 24, the display processor 274 stores the user ID of this user stored in the terminal storage 22 as the user ID of a user participating in the communication service indicated in the service display region 804. The display processor 274 then displays the communication screen 810 (see FIG. 8B) including the user output images of all the users participating in the communication service.

Then, the sender 272 of the terminal device 2 of this user sends the instruction to participate in the communication service to the server device 3 via the terminal communication I/F 21, together with the user ID of this user and/or destination information. The destination information indicates the user IDs included in the destination information received by the receiver 273, except for the user ID of this user, and the user ID of the subject user received by the receiver 273. The server receiver 331 of the server device 3 receives the instruction to participate in the communication service, and user ID, and/or destination information via the server communication I/F 31. The server sender 332 sends, via the server communication I/F 31, the instruction, user ID, and destination information to the terminal devices 2 of the users represented by the user IDs included in the destination information.

The receiver 273 of the terminal device 2 of a receiver user whose user ID is included in the destination information receives from the server device 3 the instruction to participate in the communication service, user ID, and destination information sent from the terminal device 2 of the subject user. The receiver 273 stores the received user ID in the terminal storage 22 as the user ID of a user participating in the communication service. If the communication screen 810 is displayed on the terminal device 2 of this receiver user, the display processor 274 displays the updated communication screen 810 including the user output images of all the users participating in the communication service. A series of participation processing is then completed.

The mode of start processing or participation processing for starting or participating in a communication service with a user having a predetermined relationship with a subject user is not restricted to the above-described example. For instance, in response to the subject user selecting a predetermined display object for giving an instruction to start a communication service, a selection screen including information of one or multiple mutual followers of the subject user may be displayed. In response to the subject user selecting the information indicating a mutual follower user, different start processing based on an instruction to start communication with the selected user may be executed. In this case, an information exchange screen for exchanging information with the selected user may be displayed, and in response to the subject user selecting a start button on the information exchange screen, different start processing based on an instruction to start communication with the selected user may be executed.

In a conventional information system, a user is unable to provide an instruction to start or participate in communication with another user having a predetermined relationship with the user, such as with a mutual follower of the user, by using a simple interface. In the information system 1 of this embodiment, by executing the above-described different start processing, a user interface for providing an instruction to start or participate in communication can be improved and the communication load between the server device 3 and the terminal device 2 can be reduced.

FIG. 8B illustrates an example of the communication screen 810 displayed on the display unit 23 of the terminal device 2. The communication screen 810 is a screen for a communication group including the user operating the terminal device 2 as a member user. The user operating the terminal device 2 will be called user A, and other users participating in the communication service of the communication screen 810 will be called user B1, user B2, user B3, . . . . User B1, user B2, user B3, . . . may collectively be called user B or users B.

The communication screen 810 includes at least a user output image 812a with a character object 811a of user A. In the example in FIG. 8B, three users (user B1, user B2, and user B3) other than user A are participating in the communication service. The communication screen 810 thus includes a user output image 812b1 with a character object 811b1 of user B1, a user output image 812b2 with a character object 811b2 of user B2, and a user output image 812b3 with a character object 811b3 of user B3. Hereinafter, the character objects 811b1, 811b2, and 811b3 may collectively be called the character object 811b, and the user output images 812b1, 812b2, and 812b3 may collectively be called the user output image 812b. For user A, user B is another user, and the user output image 812b of user B displayed on the terminal device 2 of user A is an another-user output image.

If no user is participating in the communication service, except for user A, the communication screen 810 only includes the user output image 812a. Every time user B participates in the communication service, a user output image 812b of this user B is included in the communication screen 810. There is no upper limit for the number of users who can participate in the communication service. For example, if nine users B other than user A are participating in the communication service, user output images 812b1, 812b2, 812b3, 812b9 are included in the communication screen 810, together with the user output image 812a of user A.

The character object 811a is animation (video image) of the character object of user A generated by the display processor 274, based on motion data of user A generated by the generator 271 and the character object and the objects in use associated with the user ID of user A in the user table T1. The motion data of user A generated by the generator 271 is the same motion data included in output information sent to the terminal device 2 of user B. Output information of user A includes voice data of user A, together with the motion data of user A. If face motion data of user A is included in the motion data of user A generated by the generator 271, the user output image 812a including the character object 811a whose facial expression changes in synchronization with the motion of the facial expression of user A is displayed. For example, when user A outputs voice, the user output image 812a including the character object 811a moving its lips is displayed. If body motion data of user A is included in the motion data of user A generated by the generator 271, the user output image 812a including the character object 811a whose corresponding parts move in synchronization with the body movement of user A is displayed.

The sender 272 of the terminal device 2 of user A sends output information of user A to the server device 3 via the terminal communication I/F 21, together with destination information (user IDs of users B (user B1, user B2, and user B3) included in the communication group). Then, the server receiver 331 of the server device 3 receives, via the server communication I/F 31, the output information of user A sent from the terminal device 2 of user A. Then, the server sender 332 of the server device 3 refers to the received user IDs of users B (user B1, user B2, and user B3) and sends the output information of user A to the terminal devices 2 of users B (user B1, user B2, and user B3) via the server communication I/F 31. Then, the receiver 273 of the terminal device 2 of user B receives the output information via the terminal communication I/F 21. The display processor 274 of the terminal device 2 of user B then displays the user output image 812a including the character object 811a based on the motion data of user A.

The character object 811b is animation (video image) of the character object of user B generated by the display processor 274, based on motion data included in output information of user B received by the receiver 273 and the character object associated with the user ID of user B in the user table T1. If face motion data of user B is included in the motion data of user B received by the receiver 273, the user output image 812b including the character object 811b whose facial expression changes in synchronization with the motion of the facial expression of user B is displayed. For example, when user B outputs voice, the user output image 812b including the character object 811b moving its lips is displayed. If body motion data of user B is included in the motion data of user B received by the receiver 273, the user output image 812b including the character object 811b whose corresponding parts move in synchronization with the body movement of user B is displayed. If voice data of user B is included in the output information of user B received by the receiver 273, the voice of user B generated by the voice output section 275 based on the voice data is output, together with the user output image 812b displayed by the display processor 274.

In this manner, as a result of the communication screen 810 including the user output images 812a and 812b being displayed, user A can hear the voice of user B while seeing the character object 811b which looks like outputting the voice of user B. Meanwhile, the character object and voice data of user A are being output by the terminal device 2 of user B. This enables user A and user B, who are participating in the communication service, to communicate with each other via their character objects.

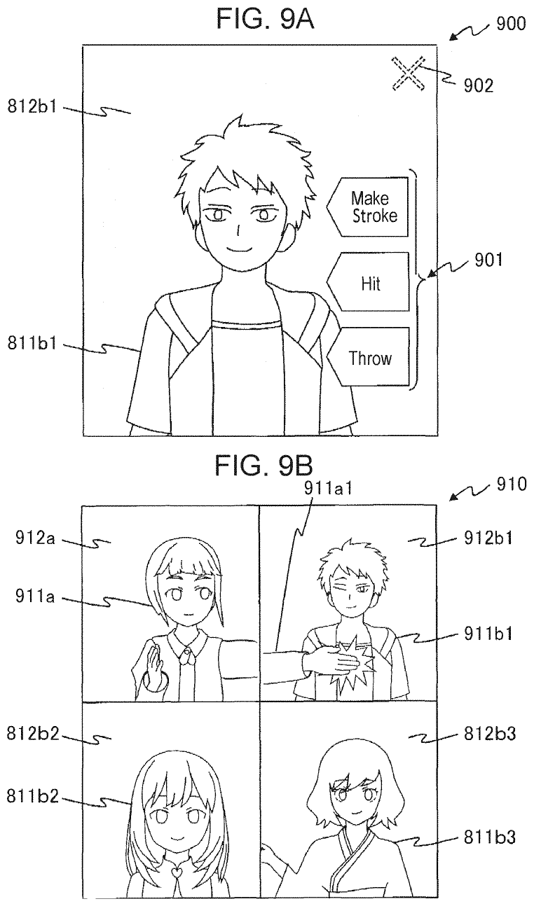

If user A wishes to make a change to the character object 811a and the user output image 812b of user B, he/she selects the user output image 812b or the character object 811b of user B. An explanation will be given of a case in which user A wishes to make a change to the user output image 812b1 of user B1 by way of example. When user A selects the character object 811b1 by operating the input unit 24, the communication screen 810 is closed, and a selection screen 900 (see FIG. 9A) is displayed. The selection screen 900 may be displayed in response to user A selecting the user output image 812b1 by operating the input unit 24.

FIG. 9A illustrates an example of the selection screen 900 displayed on the display unit 23 of the terminal device 2. The selection screen 900 is displayed in response to user A selecting the character object 811b1 or the user output image 812b1 included in the communication screen 810 (see FIG. 8B) by operating the input unit 24. When user A has selected the character object 811b1 or the user output image 812b1, the selection screen 900 may not be displayed, and instead, change option buttons 901, which will be explained below, may be displayed in the user output image 812b1.

The user output image 812b1 including the character object 811b1 of user B1 is displayed on the entirety of the selection screen 900. The selection screen 900 includes change option buttons 901 and a screen close button 902. When the selection screen 900 is displayed, the change option buttons 901 may not necessarily be included in the selection screen 900. In this case, when the input unit 24 detects that user A has performed a specific operation, such as holding down or tapping in a display region of the selection screen 900, the display processor 274 may display the change option buttons 901.

The change option buttons 901 are selection objects from which user A can select a selection object to specify the action of the character object 811a of user A to be performed on the character object 811b1 or the user output image 812b1 of user B1 selected on the communication screen 810 (see FIG. 8B). In the example in FIG. 9A, three change option buttons 901 corresponding to three actions are included in the selection screen 900. More than or less than three change option buttons 901 may be included in the selection screen 900. If some change option buttons 901 are not accommodated in the selection screen 900, the display processor 274 may display the change option buttons 901 so that user A can scroll up and down the selection screen 900. In this case, as a result of user A performing a specific operation, such as swiping for moving a finger from the bottom to the top of the selection screen 900 or flicking for tapping a finger on the selection screen 900, a change option button 901 which is not currently displayed on the selection screen 900 can be displayed on the selection screen 900.

When one of the change option buttons 901 is selected by user A, the input unit 24 inputs an instruction to make a change to a character object into the terminal processing unit 27. The input unit 24 also inputs, together with the instruction, the user ID of user B1, which corresponds to the character object (character object 811b1 selected on the communication screen 810) displayed on the selection screen 900, and the action ID corresponding to the selected change option button 901 into the terminal processing unit 27. An example of changing processing to be executed in accordance with an instruction will be discussed below.

The display processor 274 of the terminal device 2 of user A first obtains the instruction, user ID of user B1, and action ID received from the input unit 24. The display processor 274 then specifies a relative position of the character object 811b1 of user B1 on the display region of the communication screen 810 to the character object 811a of user A. The display processor 274 then refers to the motion data and passive motion data associated with the action ID and extracts the motion data and passive motion data associated with the specified relative position from the terminal storage 22.

The display processor 274 generates animation (video image) of a character object 911a of user A, based on the extracted motion data and the character object and the objects in use associated with the user ID of user A in the user table T1. The display processor 274 then generates a user output image 912a including the generated animation (video image) of the character object 911a of user A. In this manner, the display processor 274 automatically generates the character object 911a of user A, that is, a character object changed from the character object 811a, based on the positional relationship between the character object 811a of user A and the character object 811b1 of user B1 and the motion data stored in the terminal storage 22.

The display processor 274 displays the generated user output image 912a on the display unit 23. Then, the character object 911a extending its arm toward a predetermined part of a character object 911b1 of user B1 is displayed. In this case, the arm of the character object 911a of user A is drawn so that it extends to the display region of the user output image 812b of user B in FIG. 8B.

The display processor 274 also generates a user output image 912b1 including animation (video image) of an object 911a1, which is part of a newly appeared character object of user A, and animation (video image) of the changed character object 911b1 of user B1. For example, the animation of the object 911a1 is generated by the display processor 274, based on the extracted motion data and the character object and the objects in use associated with the user ID of user A in the user table T1. The animation of the character object 911b1 of user B1 reacting to the object 911a1 is generated by the display processor 274, based on the extracted passive motion data and the character object and the objects in use associated with the user ID of user B1 in the user table T1. In this manner, since the reaction of the character object 911b1 of user B1 is based on the passive motion data associated with the action ID, it can be automatically identified in accordance with the instruction from user A.

The display processor 274 displays a communication screen 910 (see FIG. 9B) including the generated user output images 912a and 912b1. The user output images 812b2 and 812b3 including the character objects 811b2 and 811b3 of user B2 and user B3, respectively, who are participating in the communication service, are the same as those in FIG. 8B. In this manner, on the communication screen 910 in FIG. 9B, the user output image 912a including the character object 911a acting based on the instruction from user A is displayed. The user output image 912b1 including the character object 911b1 of user B1, which reacts to the action of the character object 911a of user A, is also displayed.

Then, upon obtaining the instruction from user A, user ID of user B1, and the action ID received from the input unit 24, the sender 272 of the terminal device 2 of user A sends, via the terminal communication I/F 21, the instruction from user A to the server device 3, together with the user ID of user A stored in the terminal storage 22, the obtained user ID of user B1 and action ID, and destination information (user IDs of users B (user B1, user B2, and user B3). The server receiver 331 of the server device 3 receives information indicating the instruction from user A, user ID of user A, user ID of user B1, action ID, and destination information via the server communication I/F 31. Then, the server sender 332 of the server device 3 sends the information indicating the instruction from user A, user ID of user A, user ID of user B1, and action ID to the terminal devices 2 of users B (user B1, user B2, and user B3) via the server communication I/F 31.

Then, the receiver 273 of the terminal device 2 of each user B receives the information indicating the instruction from user A, user ID of user A, user ID of user B1, and action ID via the terminal communication I/F 21. The display processor 274 of the terminal device 2 of user B then specifies a relative position of the character object of user B1 on the display screen to the character object of user A on the communication screen displayed on the terminal device 2 of user B. The display processor 274 then refers to the motion data and passive motion data associated with the action ID and extracts the motion data and passive motion data related to the specified relative position from the terminal storage 22.

The display processor 274 generates animation (video image) of a character object 1001a of user A, based on the extracted motion data and the character object and the objects in use associated with the user ID of user A in the user table T1. The display processor 274 then generates a user output image 1002a including the generated animation (video image) of the character object 1001a of user A. In this manner, the display processor 274 of the terminal device 2 of user B automatically generates the changed character object 1001a of user A, based on the positional relationship between the character object of user A and the character object of user B and the motion data stored in the terminal storage 22.

The display processor 274 also generates a user output image 1002b1 including animation (video image) of an object 1001a1, which is part of a newly appeared character object of user A, and animation (video image) of a changed character object 1001b1 of user B1. The animation of the object 1001a1 is generated by the display processor 274, based on the extracted motion data and the character object and the objects in use associated with the user ID of user A in the user table T1. The animation of the character object 1001b1 of user B1 is generated by the display processor 274, based on the extracted passive motion data and the character object and the objects in use associated with the user ID of user B1 in the user table T1.

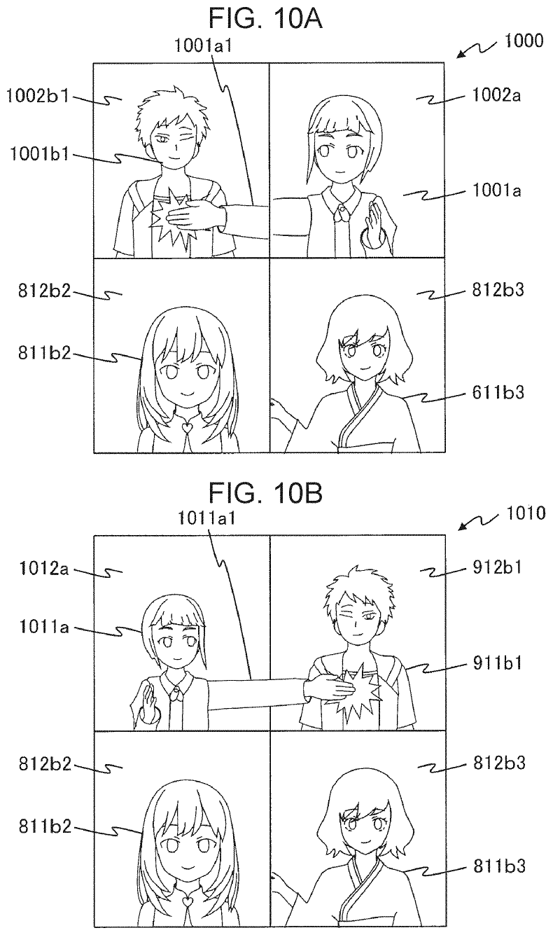

The display processor 274 displays a communication screen 1000 (see FIG. 10A) including the generated user output images 1002a and 1002b1. The user output images 812b2 and 812b3 including the character objects 811b2 and 811b3 of user B2 and user B3, respectively, who are participating in the communication service, are the same as those in FIG. 8B. Changing processing is then completed.

In the example shown in FIGS. 9B and 10A, the display positions of the character objects 911a and 911b1 in the screen displayed on the terminal device 2 of user A shown in FIG. 9B are different from those of the character objects 1001a and 1001b1 in the screen displayed on the terminal device 2 of user B shown in FIG. 10A. Hence, even with the same instruction, a change in the user output images 912a and 912b1 and a change in the user output images 1002a and 1002b1 are different from each other.

As illustrated in FIG. 9B, on the terminal device 2 of user A, the user output image 912a of user A and the user output image 912b1 of user B1 are displayed in this order from the left side of the screen. In contrast, as illustrated in FIG. 10A, on the terminal device 2 of user B1, the user output image 1002b1 of user B1 and the user output image 1002a of user A are displayed in this order from the left side of the screen. If the instruction from user A is an instruction to cause the character object of user A to hit the character object of user B1, the arm of the character object of user A extends from the right side of the screen on the terminal device 2 of user A, while it extends from the left side of the screen on the terminal device 2 of user B1. The user output image of user A and that of user B1 may be displayed in the same order on the terminal device 2 of user A and that of user B1. That is, the same screen showing the user output image of user A and that of user B1 may be displayed on the terminal device 2 of user A and that of user B1.

As described with reference to FIGS. 8B through 10A, in response to an instruction from user A, the character object of user A is changed and the user output image of user B is also changed on the terminal devices 2 of users A, B1, B2, and B3 participating in the communication service. With this configuration, user A and user B are unlikely to lose interest during communication performed via their character objects, and user A can be encouraged to continue communicating with user B.

The communication screen displayed on the terminal device 2 of user A to show that the character object of user A is changed and the user output image of user B is also changed is not limited to the communication screen 910 in FIG. 9B. For example, as illustrated in FIG. 10B, the display processor 274 may display that an object 1011a1, which is part of a character object 1011a of user A, is not included in the user output image 912b1 of user B1. In this case, in the above-described changing processing, as in a communication screen 1010 shown in FIG. 10B, the arm of the character object 1011a of user A is drawn so that it extends to outside the display region of a user output image 1012a of user A in FIG. 10B. Accordingly, the arm of the character object 1011a of user A is displayed such that it is partially superimposed on the user output image 912b1 of user B1. In this modified example, too, the terminal device 2 of user A sends information on the instruction from user A, user ID of user A, user ID of user B1, and action ID to the server device 3, together with destination information. The server device 3 then sends the information on the instruction from user A, user ID of user A, user ID of user B1, and action ID to the terminal devices 2 of users B (user B1, user B2, and user B3). The terminal device 2 of each user B is thus able to execute changing processing, based on the information on the instruction from user A, user ID of user A, user ID of user B, and action ID, and to display a screen similar to the communication screen 1010.

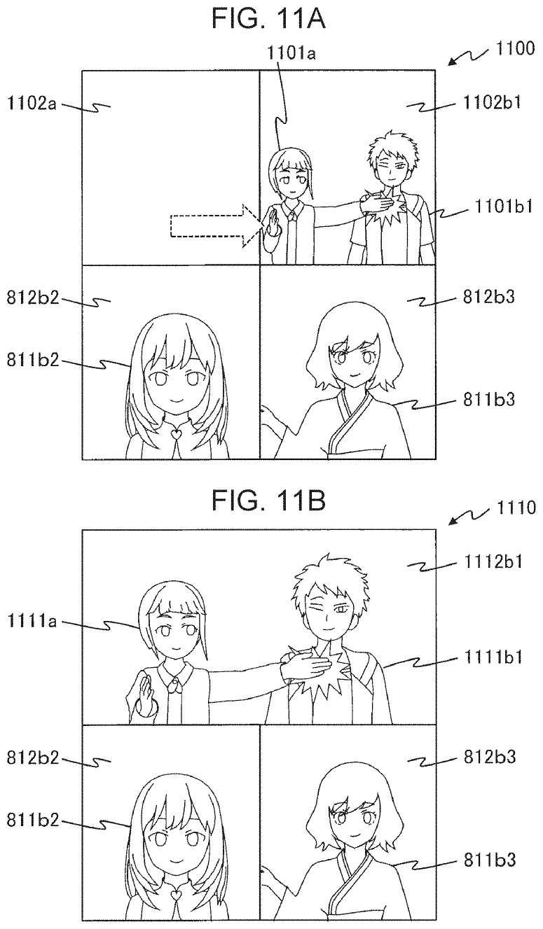

As illustrated in FIG. 11A, the display processor 274 may display a screen 1100 showing that a character object 1101a of user A appears within a user output image 1102b1 in response to an instruction from user A. In this case, the character object 811a included in the user output image 812a of user A in FIG. 8B is not included in a user output image 1102a of user A on the communication screen 1100. An example of changing processing in this modified example will be discussed below.

The display processor 274 of the terminal device 2 of user A first generates the user output image 1102a without the character object 1101a in response to the instruction from user A. The display processor 274 then obtains this instruction, user ID of user B1, and action ID received from the input unit 24. The display processor 274 then specifies a relative position of the character object 811b1 of user B1 on the display region of the communication screen 810 to the character object 811a of user A. The display processor 274 then refers to the motion data and passive motion data associated with the action ID and extracts the motion data and passive motion data associated with the specified relative position from the terminal storage 22. The display processor 274 then generates animation (video image) of the character object 1101a of user A, based on the extracted motion data and the character object and the objects in use associated with the user ID of user A in the user table T1.

Then, the display processor 274 generates animation (video image) of a character object 1101b1, based on the extracted passive motion data and the character object and the objects in use associated with the user ID of user B1 in the user table T1. The display processor 274 then generates the user output image 1102b1 including the animation (video image) of the newly appeared character object 1101a of user A and the animation (video image) of the changed character object 1101b1 of user B1. The display processor 274 displays the communication screen 1100 including the generated user output images 1102a and 1102b1. Changing processing is then completed.

In this modified example, too, the terminal device 2 of user A sends information on the instruction from user A, user ID of user A, user ID of user B1, and action ID to the server device 3, together with destination information. The server device 3 then sends the information on the instruction from user A, user ID of user A, user ID of user B1, and action ID to the terminal devices 2 of users B (user B1, user B2, and user B3). The terminal device 2 of each user B is thus able to execute changing processing, based on the information on the instruction from user A, user ID of user A, user ID of user B, and action ID, and to display a screen similar to the communication screen 1100.

On the communication screen 1100 in FIG. 11A, the display region of the user output image 1102a of user A may be decreased or removed. A communication screen 1110 shown in FIG. 11B is an example in which the display region of the user output image 1102a of user A has been removed. In the example in FIG. 11B, a user output image 1112b1 of user B including a newly appeared character object 1111a of user A is displayed to include the removed display region of the user output image 1102a. On the communication screen 1100 shown in FIG. 11A, if the display region of the user output image 1102a of user A is decreased, the user output image 1112b1 of user B is displayed to include a decreased portion of the display region of the user output image 1102a.

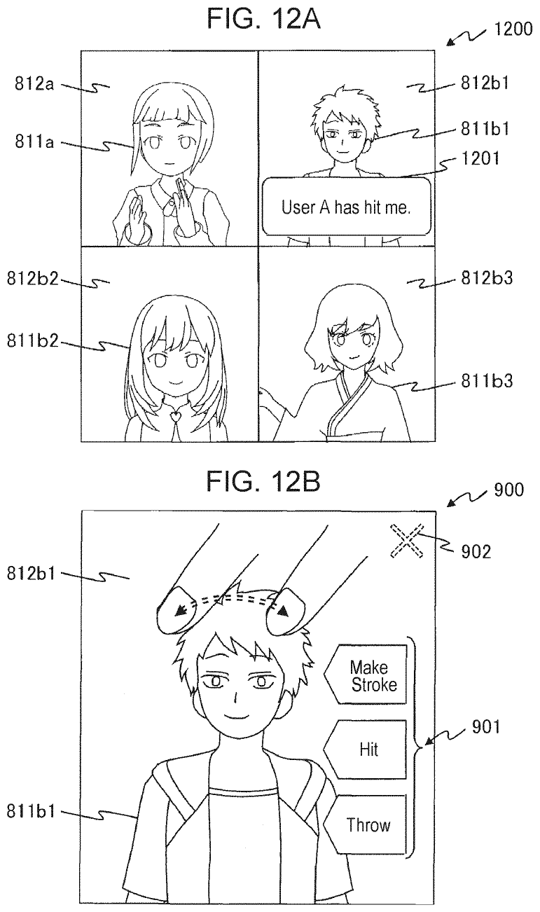

Within the user output image 812b1 shown in FIG. 8B, the display processor 274 may display a communication screen 1200 including information 1201 on the action of the character object of user A. FIG. 12A illustrates an example of the communication screen 1200. In this case, at least one of the character object 811a of user A and the character object 811b1 of user B1 may be displayed to remain the same without any change. For example, the user output image 812a including the character object 811a of user A which performs the action in accordance with the instruction from user A is displayed, while the user output image 812b1 including the information 1200 on the action of the character object 811a is displayed. In this case, the character object 811a of user A may be an image generated by the display processor 274 based on the motion data of user A and the character object and the objects in use associated with the user ID of user A in the user table T1. Likewise, the character object 811b1 of user B1 may be an image generated by the display processor 274 based on the motion data included in output information sent from the terminal device 2 of user B1 via the server device 3 and the character object and the objects in use associated with the user ID of user B1 in the user table T1.

In this modified example, too, the terminal device 2 of user A sends information on the instruction from user A, user ID of user A, user ID of user B1, and action ID to the server device 3, together with destination information. The server device 3 then sends the information on the instruction from user A, user ID of user A, user ID of user B1, and action ID to the terminal devices 2 of users B (user B1, user B2, and user B3). In the terminal device 2 of each user B, a screen, which is similar to the communication screen 1200, including the information 1201 on the action represented by the received action ID is displayed.

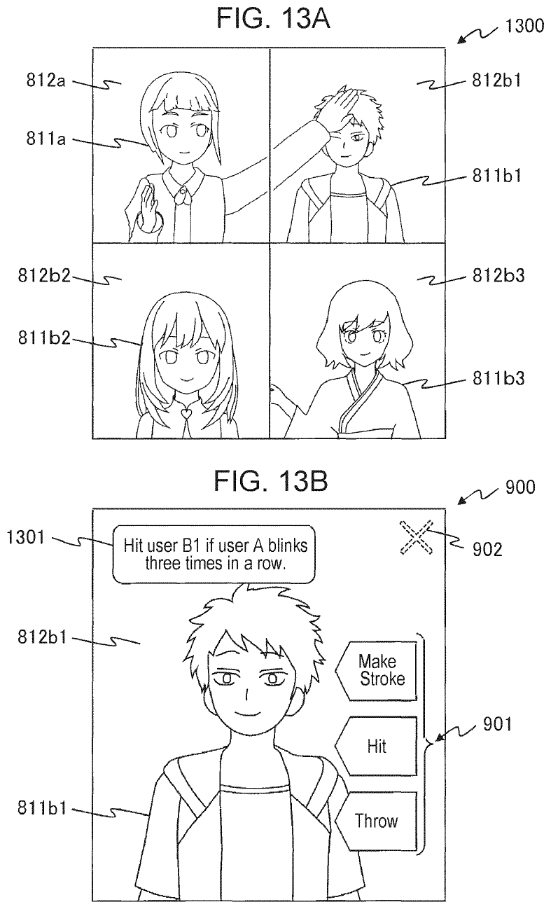

Referring back to FIG. 9A, on the selection screen 900, the interface used by user A to provide an instruction is not limited to the change option buttons 901. For example, as shown in FIG. 12B, in response to user A performing a predetermined motion on the character object 811b1 of user B1, the input unit 24 may input an instruction based on the predetermined motion into the terminal processing unit 27. If, as shown in FIG. 12B, information input from the input unit 24 to the terminal processing unit 27 indicates that user A has swiped a portion of the screen region corresponding to the head of the character object 811b1 of user B1 in the left-right direction a certain number of times, the display processor 274 determines that user A has input an instruction to make the character object 811a of user A stroke the head of the character object 811b1 of user B1. The display processor 274 and the sender 272 then execute changing processing, such as that discussed with reference to FIGS. 8B through 10A, in accordance with the instruction. As a result, a communication screen 1300 showing that the character object 811a is stroking the head of the character object 811b1 of user B1 is displayed, as shown in FIG. 13A.

The predetermined motion performed on the character object 811b1 of user B1 is not limited to the example shown in FIG. 12B. In one example, tapping on part of the screen region corresponding to the body of the character object 811b1 of user B1 may be associated with the action of the character object 811a of user A nudging the character object 811b1 of user B1. In another example, double-tapping on part of the screen region corresponding to the stomach of the character object 811b1 of user B1 may be associated with the action of the character object 811a of user A tickling the character object 811b1 of user B1.

The display processor 274 and the sender 272 may use imaging data continuously output from the imaging unit 25 without using the input unit 24 to determine that an instruction is input from user A. The display processor 274 and the sender 272 constantly monitor imaging data and determine whether an instruction is input from user A. As illustrated in another example of the selection screen 900 shown in FIG. 13B, the display processor 274 and the sender 272 determine whether user A has blinked a predetermined number of times or more during a preset period (two seconds, for example). In the example in FIG. 13B, information 1301 on the action based on the instruction from user A is displayed on the selection screen 900. However, the information 1301 may not necessarily be displayed on the selection screen 900. For example, in this determining processing, a learned discriminant model which has learned about the human blinking by using conventional machine learning may be employed. Data used for determining processing is not limited to imaging data continuously obtained from the imaging unit 25. For example, motion data generated by the generator 271 may be used.

In the terminal storage 22, the action based on an instruction and the action ID are stored in association with each other. When the display processor 274 and the sender 272 determine that user A has performed the action based on the instruction, they refer to the action ID associated with this action and the user ID of user B1 corresponding to the character object displayed on the selection screen 900. The display processor 274 and the sender 272 then execute changing processing by using the identified action ID, user ID of user B1, and user ID of user A stored in the terminal storage 22.

As described above, during the execution of a communication service, the terminal device 2 is able to make a change to the character object of user A and the user output image of user B, based on imaging data of user A, for example. User A and user B are thus unlikely to lose interest during communication performed via their character objects, and user A can be encouraged to continue communicating with user B.

The interface screen used by user A to provide an instruction is not limited to the selection screen 900. For example, a user output image of a new user participating in an already started communication service may include objects having functions similar to the change option buttons 901.

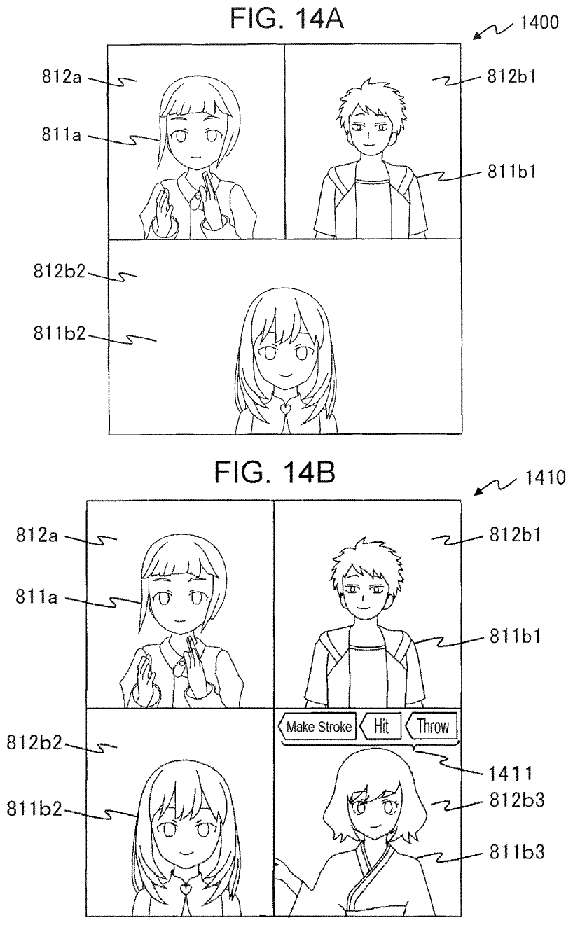

FIG. 14A illustrates an example of a communication screen 1400 including user output images 812a, 812b1, and 812b2 of user A, user B1, and user B2, respectively, who are participating in the communication service. FIG. 14B illustrates an example of a communication screen 1410 when user B3 has just participated in the communication service in which user A, user B1, and user B2 are participating.

The communication screen 1410 is a screen on which change option buttons 1411 are added to the communication screen 810 shown in FIG. 8B. When user B3, who is a new user, has just participated in the communication service, the display processor 274 displays a user output image 812b3 including a character object 811b3 of user B3 and the change option buttons 1411. After the lapse of a predetermined time (three minutes, for example) after the change option buttons 1411 are displayed, the display processor 274 may delete the change option buttons 1411.

The change option buttons 1411 have a similar function as the change option buttons 901. For example, when user A selects one of the change option buttons 1411 by operating the input unit 24, the input unit 24 inputs an instruction into the terminal processing unit 27, together with the user ID of user B3, who is a new user, and the action ID corresponding to the selected change option button 1411. The display processor 274 and the sender 272 then execute changing processing in accordance with the input instruction.

In this manner, user A can perform a certain operation right away to make a change to the user output image 812b3 of user B3, who has just participated in the communication service. Hence, the information system 1 does not let user A lose interest during communication performed via the character objects and can encourage user A to continue communicating with user B. Additionally, displaying the change option buttons 1411 can make it easy for users who have already participated in the communication service (user A, user B1, and user B2) to make a change to the character object of user B3, which is a new user having just participated in the communication service. The information system 1 can thus give a new user, such as user B3, opportunities to communicate with existing users, thereby making it easy for the new user to actively participate in communication of a communication group.

As an interface screen used by user A to provide an instruction, a selection screen 1500, which is simultaneously displayed on the terminal devices 2 of multiple users participating in the communication service, may be displayed. For example, as a result of user A performing a predetermined operation (such as swiping for moving a finger from the bottom to the top of the screen) on the communication screen 810, the selection screen 1500 including plural change option buttons may be displayed such that it is superimposed on the communication screen 810.

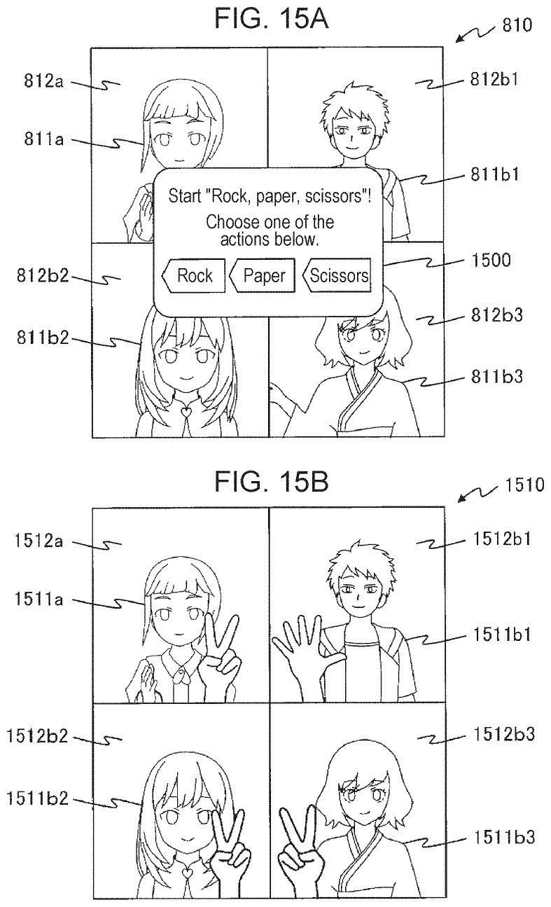

FIG. 15A illustrates an example of the selection screen 1500. In the example in FIG. 15A, three change option buttons corresponding to three actions are included in the selection screen 1500. When giving an instruction on the selection screen 1500, user A does not have to select the user output image of user B (user B1, user B2, and user B3) to change its user output image.

For example, in response to user A performing a predetermined operation on the communication screen 810 by operating the input unit 24, the input unit 24 inputs an instruction to display the selection screen 1500 into the terminal processing unit 27. Upon obtaining the instruction to display the selection screen 1500 from the input unit 24, the display processor 274 of the terminal device 2 of user A displays the selection screen 1500 on the display unit 23. The sender 272 of the terminal device 2 of user A sends, via the terminal communication I/F 21, information indicating the instruction to the server device 3, together with the user ID of user A stored in the terminal storage 22 and destination information. The server receiver 331 of the server device 3 receives information indicating the instruction, user ID of user A, and destination information via the server communication I/F 31. Then, the server sender 332 of the server device 3 sends the information indicating the instruction and user ID of user A to the terminal devices 2 of users B (user B1, user B2, and user B3) via the server communication I/F 31.

Then, the receiver 273 of the terminal device 2 of each user B receives the information indicating the instruction to display the selection screen 1500 and user ID of user A via the terminal communication I/F 21. The display processor 274 of the terminal device 2 of user B displays the selection screen 1500 on the display unit 23, as in the terminal device 2 of user A. The display processor 274 may extract the name of user A associated with the user ID of user A from the user table T1 and add it to the selection screen 1500. In place of a predetermined operation performed by user A, in response to a predetermined operation by one of users B (user B1, user B2, and user B3), the selection screen 1500 may be displayed on the terminal devices 2 of users A, B1, B2, and B3.

In this manner, the selection screen 1500 is displayed on the terminal devices 2 of users A, B1, B2, and B3. When users A, B1, B2, and B3 each select one of the three change option buttons included in the selection screen 1500 by operating the input unit 24, the display processor 274 and the sender 272 of each terminal device 2 execute changing processing. An example of changing processing executed by the terminal device 2 of user A will be discussed below.

Upon obtaining the instruction received from the input unit 24 and the action ID corresponding to the selected change option button, the display processor 274 of the terminal device 2 of user A extracts the motion data associated with the action ID from the terminal storage 22. The display processor 274 then generates a user output image 1512a including animation (video image) of a character object 1511a of user A, based on the extracted motion data and the character object and the objects in use associated with the user ID of user A in the user table T1.

Upon obtaining the instruction received from the input unit 24 and the action ID, the sender 272 of the terminal device 2 of user A sends information indicating the instruction to the server device 3 via the terminal communication I/F 21, together with the user ID of user A stored in the terminal storage 22, obtained action ID, and destination information. The server receiver 331 of the server device 3 receives information indicating the instruction, user ID of user A, action ID, and destination information via the server communication I/F 31. Then, the server sender 332 of the server device 3 sends the information indicating the instruction, user ID of user A, and action ID to the terminal devices 2 of users B (user B1, user B2, and user B3) via the server communication I/F 31.

The receiver 273 of the terminal device 2 of each user B receives the information indicating the instruction, user ID of user A, and the action ID via the terminal communication I/F 21. Then, the display processor 274 of the terminal device 2 of user B extracts the motion data associated with the action ID from the terminal storage 22. The display processor 274 then generates the user output image 1512a including animation (video image) of the character object 1511a of user A, based on the extracted motion data and the character object and the objects in use associated with the user ID of user A in the user table T1.

The receiver 273 of the terminal device 2 of user A receives the information indicating the instruction, user ID of user B1, and the action ID sent from the terminal device 2 of user B1 via the server device 3. Then, the display processor 274 extracts the motion data associated with the action ID from the terminal storage 22. The display processor 274 then generates a user output image 1512b1 including animation (video image) of a character object 1511b1 of user B1, based on the extracted motion data and the character object and the objects in use associated with the user ID of user B1 in the user table T1. Likewise, upon receiving instructions, user IDs of user B2 and user B3, and action IDs sent from the terminal devices 2 of user B2 and user B3, the display processor 274 generates a user output image 1512b2 including animation (video image) of a character object 1511b2 of user B2 and a user output image 1512b3 including animation (video image) of a character object 1511b3 of user B3.

The display processor 274 of the terminal device 2 of user A then displays a communication screen 1510 (see FIG. 15B) including the generated user output images 1512a, 1512b1, 1512b2, and 1512b3. The display processors 274 of the terminal devices 2 of users B1, B2, and B3 also execute similar display processing. In the example in FIG. 15B, each user selects one of specific actions, which are “rock”, “paper”, and “scissors” actions having a “trilemma” relationship. In this case, each user (users A, B1, B2, and B3) gives a verbal instruction to make the corresponding character object play a “trilemma” game (such as “Rock, paper, scissors”). On the terminal device 2 of each user, every time each user gives an instruction to start a game, such as “Rock, paper, scissors, shoot!”, one of the “rock”, “paper”, and “scissors” actions performed by the character object of each user is displayed. In this manner, user A can enjoy playing a “trilemma” game, such as “Rock, paper, scissors”, with user B. During communication performed via their character objects, user A and user B do not lose interest in communication and user A can be encouraged to continue communicating with user B.

Within a preset period (ten seconds, for example) after the selection screen 1500 is displayed, the terminal device 2 of user A may not display the user output images 1512b1, 1512b2, and 1512b3 of users B1, B2, and B3 based on the instructions sent from the terminal devices 2 of users B1, B2, and B3. Then, after the lapse of the preset period, the terminal device 2 of user A may display the user output image 1512a of user A and the user output images 1512b1, 1512b2, and 1512b3 of users B1, B2, and B3. In this case, if the terminal device 2 of user A obtains the instruction from user A received from the input unit 24 and also the instructions received from the terminal devices 2 of all users B1, B2, and B3, the terminal device 2 of user A may display the user output image 1512a of user A and the user output images 1512b1, 1512b2, and 1512b3 of users B1, B2, and B3 even if the preset period has not yet elapsed. After the lapse of the preset period, an instruction from each user may not be received. This can prevent a user from deciding the action of its character object after looking at the action of the character object of another user. The server device 3 may judge the result of a game, based on the action ID received together with the instruction from the terminal device 2 of user A and the action IDs received together with the instructions from the terminal devices 2 of users B1, B2, and B3. In this case, the server device 3 may send the result of the game to the terminal device 2 of each user, and the result of the game may be displayed on the terminal device 2 of each user. The terminal device 2 of each user may group users having performed the same action together.

(Operation Sequence of Information System 1)

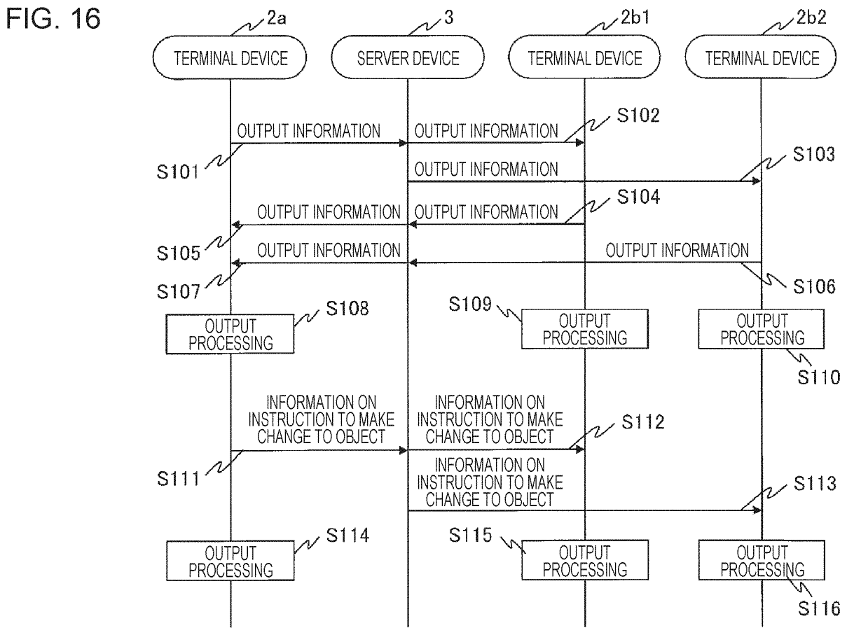

FIG. 16 illustrates an example of an operation sequence of the information system 1. The operation sequence is executed mainly by the terminal processing unit 27 and the server processing unit 33 with other elements of the terminal device 2 and the server device 3 collaboratively, based on the control programs stored in the terminal storage 22 and the server storage 32. A description will be given below, assuming that user A operates a terminal device 2a, user B1 operates a terminal device 2b1, and user B2 operates a terminal device 2b2.

In step S101, the sender 272 of the terminal device 2a sends, via the terminal communication I/F 21, output information including character video data of user A, voice data of user A output from the microphone 26, and the user ID of user A to the server device 3, together with destination information. The character video data includes motion data of user A generated by the generator 271 based on imaging data continuously output from the imaging unit 25. In this sending processing of the sender 272, the destination information may not necessarily be sent. Step S101 is executed at predetermined time intervals (every two seconds, for example) until this distribution event is completed. Accordingly, steps S101 through S110 are intermittently executed.

Then, in step S102, the server sender 332 of the server device 3 sends, via the server communication I/F 31, the output information received from the terminal device 2a to the terminal device 2b1 by referring to the destination information. In step S103, the server sender 332 also sends the output information to the terminal device 2b2.

In step S104, the sender 272 of the terminal device 2b1 sends, via the terminal communication I/F 21, output information including character video data of user B1, voice data of user B1, and the user ID of user B1 to the server device 3, together with destination information. Then, in step S105, the server sender 332 of the server device 3 sends, via the server communication I/F 31, the output information received from the terminal device 2b1 to the terminal device 2a by referring to the destination information. The server sender 332 also sends the output information to the terminal device 2b2.

In step S106, the sender 272 of the terminal device 2b2 sends, via the terminal communication I/F 21, output information including character video data of user B2, voice data of user B2, and the user ID of user B2 to the server device 3, together with destination information. Then, in step S107, the server sender 332 of the server device 3 sends, via the server communication I/F 31, the output information received from the terminal device 2b2 to the terminal device 2a by referring to the destination information. The server sender 332 also sends the output information to the terminal device 2b1.

In step S108, the display processor 274 of the terminal device 2a displays on its display unit 23 a communication screen including a user output image with a character object of user A based on the output information of user A, a user output image with a character object of user B1 based on the output information of user B1, and a user output image with a character object of user B2 based on the output information of user B2. The display processor 274 also outputs voice of user B1 and user B2 in step S108.

As in step S108, in step S109, the display processor 274 of the terminal device 2b1 displays on its display unit 23 a communication screen including the user output image with the character object of user A based on the output information of user A, the user output image with the character object of user B1 based on the output information of user B1, and the user output image with the character object of user B2 based on the output information of user B2. The display processor 274 also outputs voice of user A and that of user B2 in step S109.

As in step S108, in step S110, the display processor 274 of the terminal device 2b2 displays on its display unit 23 a communication screen including the user output image with the character object of user A based on the output information of user A, the user output image with the character object of user B1 based on the output information of user B1, and the user output image with the character object of user B2 based on the output information of user B2. The display processor 274 also outputs voice of user A and that of user B1 in step S110.

In step S111, the sender 272 of the terminal device 2a sends, via the terminal communication I/F 21, information on an instruction input by user A using the input unit 24 to the server device 3, together with destination information. Then, in step S112, the server sender 332 of the server device 3 sends, via the server communication I/F 31, this information received from the terminal device 2a to the terminal device 2b1 by referring to the destination information. In step S113, the server sender 332 also sends this information to the terminal device 2b2.

In step S114, based on the instruction received from user A using the input unit 24, the display processor 274 of the terminal device 2a makes a change to the character object of user A and also to at least one of the user output image of user B1 and that of user B2, and displays the resulting character object and user output image on the display unit 23.

In step S115, based on the information on the instruction sent from the terminal device 2a of user A, the display processor 274 of the terminal device 2b1 makes a change to the character object of user A and also to at least one of the user output image of user B1 and that of user B2, and displays the resulting character object and user output image on the display unit 23.

In step S116, based on the information on the instruction sent from the terminal device 2a of user A, the display processor 274 of the terminal device 2b2 makes a change to the character object of user A and also to at least one of the user output image of user B1 and that of user B2, and displays the resulting character object and user output image on the display unit 23.

As discussed above in detail, in the information system 1 of the embodiment, the changed character object of user A and the changed user output image of at least one user B are displayed in accordance with an instruction from user A. In this manner, in the information system 1 of the embodiment, it is possible to change output from the terminal device 2 by user A or at least one user B during the execution of a communication service. This can encourage users to continue communicating with each other.

### First Modified Example

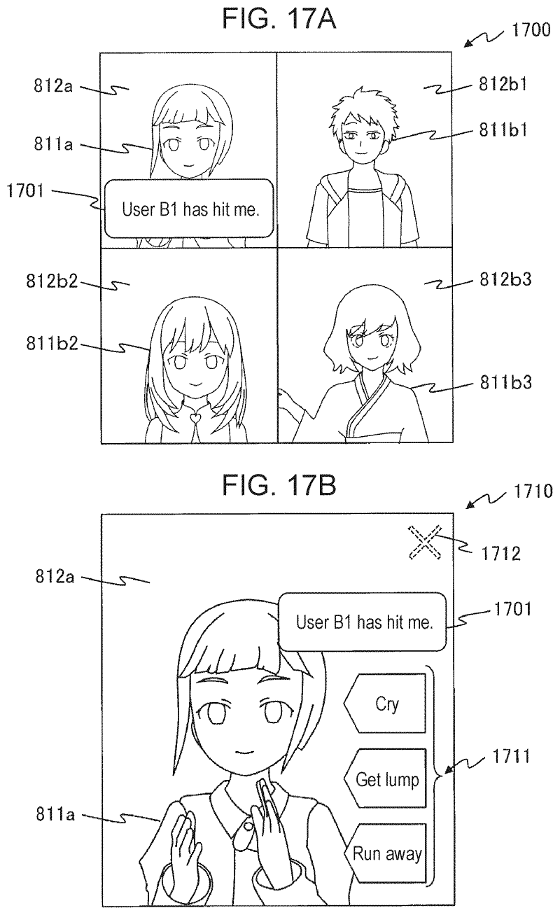

The disclosure is not restricted to the above-described embodiment. For example, as the motion data indicating the action based on an instruction to make a change to an object, multiple types of passive motion data associated with the action ID may be stored. For example, multiple types of passive motion data associated with a relative position on the display screen of a passive character object to an active character object performing an action may be stored. In this case, when the terminal device 2 of a subject user receives an instruction from another user via the server device 3, the display processor 274 of the terminal device 2 of the subject user displays a selection screen 1710 for selecting a reaction of the character object of the subject user in response to the action performed by the character object of the user having sent the instruction. This enables the subject user to select a reaction of its passive character object from multiple reactions. This makes it possible to encourage users to continue communicating with each other. Reaction processing in a first modified example will be described below with reference to FIGS. 17A and 17B.

FIG. 17A illustrates an example of a communication screen 1700 displayed on the display unit 23 of the terminal device 2 of user A after an instruction is received from user B1. In the example of FIG. 17A, the sender 272 of the terminal device 2 of user B1 sends, via the terminal communication I/F 21, information on an instruction to make a change to an object corresponding to the change option button 901 selected by user B1 on the selection screen 900 to the server device 3, together with destination information. Together with the information on the instruction, the user ID of user B1, user ID of user A indicated by the character object (passive character object) displayed on the selection screen, and action ID corresponding to the selected change option button 901 are also sent to the server device 3.

The server receiver 331 of the server device 3 then receives the information on the instruction, user ID of user B1, user ID of user A, action ID, and destination information via the server communication I/F 31. The sender 332 of the server device 3 then sends, via the server communication I/F 31, the information on the instruction, user ID of user B1, user ID of user A, and action ID to the terminal devices 2 of user A, user B2, and user B3.

The receiver 273 of the terminal device 2 of user A receives the information on the instruction, user ID of user B1, user ID of user A, and action ID via the terminal communication I/F 21. Then, in the display region of the user output image 812a of user A included in the communication screen 1700, the display processor 274 of the terminal device 2 of user A displays information 1701 indicating that user B has performed the action represented by the action ID on user A, as illustrated in FIG. 17A.

When user A has selected the information 1701 or the user output image 812a including the information 1701 by operating the input unit 24, the display processor 274 of the terminal device 2 of user A displays the selection screen 1710. When user A has selected the information 1701 or the user output image 812a including the information 1701 by operating the input unit 24, the display processor 274 may display reaction selection buttons 1711, which will be discussed later, on the communication screen 1700 without displaying the selection screen 1710. Alternatively, upon receiving the information indicating the instruction, user ID of user B1, user ID of user A, and action ID by the receiver 273 of the terminal device 2 of user A, the display processor 274 may automatically display the selection screen 1710 without displaying the information 1701 or after the lapse of a predetermined time after the information 1701 is displayed.

FIG. 17B illustrates an example of the selection screen 1710 displayed on the display unit 23 of the terminal device 2 of user A. The user output image 812a including the character object 811a of user A is displayed on the entirety of the selection screen 1710. The selection screen 1710 includes the information 1701 and the reaction selection buttons 1711. The reaction selection buttons 1711 illustrated in FIG. 17B include “cry”, “get lump” and “run away”, which each correspond to reactions that may be selected by a user. For example, when a user selects “cry”, character object 811a may be displayed as performing a cry action. When the user selects “get lump”, the character object 811a may be modified to have a lump on the head (or other location) of character object 811a. When the user selects “run away”, the character object 811a may be displayed as performing a run away action, such as moving out of a display area of output image 812a. Note, however, that “cry”, “get lump” and “run away” are merely examples and the reaction selection buttons 1711 are not limited to these reaction selections.

When the selection screen 1710 is displayed, the reaction selection buttons 1711 may not necessarily be included in the selection screen 1710. In this case, when the input unit 24 detects that user A has performed a specific operation, such as holding down on the display region of the selection screen 1710, the display processor 274 may display the reaction selection buttons 1711.

The multiple reaction selection buttons 1711 correspond to the action ID sent together with the information on the instruction from user B1 and also to the respective types of motion data associated with the relative position of the character object 811b1 of user B1 to the character object 811a of user A on the communication screen 1700. That is, the reaction selection buttons 1711 correspond to the respective types of reactions of the character object 811a to the action of the character object 811b1 of user B1 performed based on the instruction from user B1.

As a result of user A selecting one of the reaction selection buttons 1711 by operating the input unit 24, the input unit 24 inputs information indicating the selected reaction button 1711 into the terminal processing unit 27. Based on the information on the selected reaction button 1711, the display processor 274 of the terminal device 2 of user A extracts the passive motion data corresponding to the selected reaction button 1711 from the terminal storage 22. The display processor 274 also extracts the motion data associated with the relative position and the action ID sent together with the instruction from user B1.

The display processor 274 generates the user output image 812b1 including animation (video image) of the character object 811b1 of user B1, based on the extracted motion data and the character object and the objects in use associated with the user ID of user B1 in the user table T1. The display processor 274 also generates the user output image 812a including animation (video image) of the character object 811a of user A, based on the extracted passive motion data and the character object and the objects in use associated with the user ID of user A in the user table T1. The user output image 812a may include part of the generated character object 811b1 of user B1.

The sender 272 of the terminal device 2 of user A sends information on a reaction instruction, information on the selected reaction selection button 1711, and user ID of user A to the server device 3, together with destination information. The server device 3 then sends the information on the reaction instruction, information on the selected reaction selection button 1711, and user ID of user A to the terminal devices 2 of users B1, B2, and B3. If the destination information is stored in the server device 3, it may not necessarily be sent by the terminal device 2 of user A. The terminal devices 2 of users B1, B2, and B3 are thus able to execute reaction processing based on the received information on the reaction instruction, information on the selected reaction selection button 1711, and user ID of user A, and to display the action of the character object of user B1 and the reaction of the character object of user A, as in the terminal device 2 of user A.

As described above, from among multiple reactions, a user can select a reaction of its character object in response to the action performed by the character object of another user. The information system 1 can thus implement a variety of expressive communication between users. The information system 1 also lets a user choose one of the multiple reactions, instead of the reaction based on the action of the user. This enables the user to instantly and intuitively select a reaction and express the selected reaction, thereby enhancing the usability. In this manner, the information system 1 can encourage users to continue communicating with each other. If no reaction selection button 1711 is selected after the lapse of a predetermined time (ten seconds, for example) after the selection screen 1710 is displayed, the selection screen 1710 may be closed. In this case, the reaction of user A based on automatically selected motion data may be displayed.

The selection screen 1710 shown in FIG. 17B may be displayed before user A participates in a communication service, and user A may select one of the reaction selection buttons 1711 in advance. In this case, when the receiver 273 of the terminal device 2 of user A receives information on an instruction from user B1, user ID of user B1, user ID of user A, and action ID, the display processor 274 of the terminal device 2 of user A displays the character object of user A which reacts based on the preselected reaction selection button 1711. The sender 272 of the terminal device 2 of user A sends information on a reaction instruction, information on the preselected reaction selection button 1711, and user ID of user A to the server device 3, together with destination information. The server device 3 then sends the information on the reaction instruction, information on the preselected reaction selection button 1711, and user ID of user A received from the terminal device 2 of user A to the terminal devices 2 of users B1, B2, and B3. The terminal devices 2 of users B1, B2, and B3 are thus able to execute reaction processing based on the received information on the reaction instruction, information on the preselected reaction selection button 1711, and user ID of user A, and to display the action of the character object of user B1 and the preselected reaction of the character object of user A, as in the terminal device 2 of user A.

### Second Modified Example

The character object of user A may automatically act in accordance with an instruction from user B1 and then perform an action selected by user A. In this case, plural types of motion data and plural types of first passive motion data are stored in the terminal storage 22 in association with an action ID. Each of the plural types of motion data associated with a corresponding action ID is also associated with a relative position on a display screen of a passive character object to an active character object performing the action represented by this action ID. Each of the plural types of first passive motion data associated with a corresponding action ID is also associated with a relative position on a display screen of a passive character object to an active character object performing the action represented by this action ID. In the terminal storage 22, plural types of second passive motion data associated with an action ID are also stored. More specifically, for each relative position on a display screen of a passive character object to an active character object performing the action represented by a certain action ID, second passive motion data associated with this action ID is stored.

The display processor 274 of the terminal device 2 of user A first specifies a relative position on the display screen of the character object 811a of user A to the displayed character object 811b1 of user B1. The display processor 274 then extracts the motion data associated with the specified relative position from the terminal storage 22 from among plural types of motion data associated with the action ID received together with an instruction from user B1. The display processor 274 then generates animation (video image) of the character object 811b1 of user B1, based on the extracted motion data and the character object and the objects in use associated with the user ID of user B1 in the user table T1. The display processor 274 generates a user output image 812b1 including the generated animation (video image) of the character object 811b1 of user B1.

Then, the display processor 274 extracts the first passive motion data associated with the specified relative position from the terminal storage 22 from among plural types of first passive motion data associated with the action ID received together with the instruction from user B1. The display processor 274 then generates animation (video image) of the character object 811a of user A, based on the extracted first passive motion data and the character object and the objects in use associated with the user ID of user A in the user table T1. The display processor 274 then generates a user output image 812a including the generated animation (video image) of the character object 811a of user A. Then, the display processor 274 displays the generated user output images 812a and 812b1.

The sender 272 of the terminal device 2 of user A sends information on a first reaction instruction, information on the first passive motion data, and user ID of user A to the server device 3, together with destination information. The server device 3 then sends the received information on the first reaction instruction, information on the first passive motion data, and user ID of user A to the terminal devices 2 of users B1, B2, and B3. This enables the terminal devices 2 of users B1, B2, and B3, as in the terminal device 2 of user A, to display the action of the character object of user B1 and the reaction of the character object of user A corresponding to the first passive motion data, based on the received information on the first reaction instruction, information on the first passive motion data, and user ID of user A.

While the reaction of the character object of user A corresponding to the first passive motion data based on the instruction from the terminal device 2 of user B1 is being displayed, if user A selects one of the reaction selection buttons 1711 by operating the input unit 24, the input unit 24 outputs information indicating the selected reaction selection button 1711 to the terminal processing unit 27. Based on the information on the selected reaction selection button 1711, the display processor 274 of the terminal device 2 of user A extracts the second passive motion data associated with the selected reaction selection button 1711 from among plural types of second passive motion data associated with the action ID sent together with the instruction from user B1 and also with the specified relative position. The display processor 274 then generates a user output image 812a including animation (video image) of the character object 811a of user A, based on the extracted second passive motion data and the character object and the objects in use associated with the user ID of user A in the user table T1.

After displaying the user output image 812a including the animation (video image) of the character object 811a of user A based on the first passive motion data, the display processor 274 displays the user output image 812a including the animation (video image) of the character object 811a of user A based on the second passive motion data. This enables the character object of user A to react to the action of the character object of user B1 based on the first passive motion data and then to react based on the second passive motion data selected by user A.

The sender 272 of the terminal device 2 of user A sends information on a second reaction instruction, information indicating the selected reaction selection button 1711, and user ID of user A to the server device 3, together with destination information. The server device 3 then sends the received information on the second reaction instruction, information indicating the selected reaction selection button 1711, and user ID of user A to the terminal devices 2 of users B1, B2, and B3. This enables the terminal devices 2 of users B1, B2, and B3, as in the terminal device 2 of user A, to display the action of the character object of user B1 and the reaction of the character object of user A corresponding to the second passive motion data, based on the received information on the second reaction instruction, second passive motion data corresponding to the information indicating the selected reaction selection button 1711, and user ID of user A, after displaying the reaction of the character object of user A based on the first passive motion data. If the terminal devices 2 of users B1, B2, and B3 do not receive information on the second reaction instruction for a predetermined display period, they may not display the reaction of the character object of user A corresponding to the second passive motion data.

As described above, while the reaction of a character object of a subject user, which is automatically executed first, in response to the action of another user is being displayed, the subject user can select another reaction from among plural reactions. In this manner, in the information system 1, a character object of a subject user can first quickly react to the action of the character object of another user and then perform a natural reaction selected by the user. The information system 1 can thus encourage users to continue communicating with each other.

### Third Modified Example

In response to user A providing an instruction by operating the input unit 24, the display processor 274 may automatically make a change to the character object of a user (user B2 and/or user B3, for example) other than the character object of user A and that of user B1 which acts based on the instruction. For example, the display processor 274 of the terminal device 2 of each user extracts predetermined motion data, such as that indicating that a character object is surprised, from the terminal storage 22 and automatically causes the character object of user B2 and that of user B3 to react based on the extracted predetermined motion data in accordance with the instruction from user A. This makes, not only the users (user A and user B1) related to the instruction, but also other users, be involved in the content of the instruction. It is thus possible to encourage users to continue communicating with each other.

### Fourth Modified Example

If a predetermined trigger condition is satisfied when an instruction to make a change to an object is input from a user, a specific type of passive motion data associated with an action ID may be applied. This will be described below through illustration of a fourth modified example with reference to FIGS. 9A and 9B.

The selection screen 900 shown in FIG. 9A is a screen for selecting the action of the character object of user A for the character object of user B1. For example, the predetermined trigger condition may be a condition that, during a preset period, the number of times the character object of user A has performed action X for the character object of user B1 exceeds a first predetermined number, the number of times the character object of user B2 has performed action X for the character object of user B1 exceeds the first predetermined number, and the number of times the character object of user B3 has performed action X for the character object of user B1 exceeds the first predetermined number. Action X is an action performed in response to an instruction input from a user. The predetermined trigger condition may be a condition that, during the preset period, the number of times the character object of user A has performed a certain action for the character object of user B1 exceeds the first predetermined number, the number of times the character object of user B2 has performed a certain action for the character object of user B1 exceeds the first predetermined number, and the number of times the character object of user B3 has performed a certain action for the character object of user B1 exceeds the first predetermined number. Regarding this trigger condition, “action” that the character object of user A performs is any type of action if the character object of user A can perform. Likewise, regarding this trigger condition, “action” that the character object of user B2 performs is any type of action if the character object of user B2 can perform, and “action” that the character object of user B3 performs is any type of action if the character object of user B3 can perform. The predetermined trigger condition may be a condition that, during the preset period, the total number of times the character object of user A has performed action X for the character object of user B1, the character object of user B2 has performed action X for the character object of user B1, and the character object of user B3 has performed action X for the character object of user B1 exceeds a second predetermined number. The predetermined trigger condition may be a condition that, during the preset period, the total number of times the character object of user A has performed a certain action for the character object of user B1, the character object of user B2 has performed a certain action for the character object of user B1, and the character object of user B3 has performed a certain action for the character object of user B1 exceeds the second predetermined number. Regarding this trigger condition, “action” that the character object of user A performs is any type of action if the character object of user A can perform. Likewise, regarding this trigger condition, “action” that the character object of user B2 performs is any type of action if the character object of user B2 can perform, and “action” that the character object of user B3 performs is any type of action if the character object of user B3 can perform. The preset period may be a period within one hour from the start time of a communication service in which user A is currently participating or a period from the current time to the time fifteen seconds before the current time. The first predetermined number and the second predetermined number may be the same number or different numbers.

The predetermined trigger condition may be a condition that, during the preset period, the total number of times the character object of user B1 has reacted to action X performed by the character object of user A, the character object of user B1 has reacted to action X performed by the character object of user B2, and the character object of user B1 has reacted to action X performed by the character object of user B3 exceeds a third predetermined number. The predetermined trigger condition may be a condition that, during the preset period, the number of times the character object of user B1 has reacted to action X performed by the character object of user A exceeds the third predetermined number, the number of times the character object of user B1 has reacted to action X performed by the character object of user B2 exceeds the third predetermined number, or the number of times the character object of user B1 has reacted to action X performed by the character object of user B3 exceeds the third predetermined number.

If the predetermined trigger condition is satisfied when an instruction is input from user A, among plural types of passive motion data associated with the action ID of the action selected by user A this time and with the relative position on the display screen of the character object 811a of user A to the character object 811b1 of user B1, a specific type of passive motion data is used to make a change to the character object of user B1. If the predetermined trigger condition is not satisfied when an instruction is input from user A, among the above-described plural types of passive motion data, a regular type of passive motion data is used to make a change to the character object of user B1.

The action of the character object displayed by using the specific type of passive motion data is more intense and/or quicker, for example, than that using the regular type of passive motion data. The character object displayed by using the specific type of passive motion data may act differently from that using the regular type of passive motion data. The character object displayed by using the specific type of passive motion data may perform the same action as that using the regular type of passive motion data and also perform a different action from that using the regular type of passive motion data.

The predetermined trigger condition may be a condition that, during the preset period, the total number of times the character object of user A having input an instruction this time has performed the same action X for the character object of user B1, the character object of user B2, and the character object of user B3 exceeds a fourth predetermined number. The predetermined trigger condition may be a condition that, during the preset period, the total number of times the character object of user A having input an instruction this time has performed a certain action for the character object of user B1, a certain action for the character object of user B2, and a certain action for the character object of user B3 exceeds the fourth predetermined number. Regarding this trigger condition, “action” that the character object of user A performs is any type of action if the character object of user A can perform. The predetermined trigger condition may be a condition that, during the preset period, individual users perform a predetermined action for the character object of user B1 in a predetermined order. For example, the character object of user A performs action X for the character object of user B1, then, the character object of user B2 performs action X for the character object of user B1, and then, the character object of user B3 performs action X for the character object of user B1.

The predetermined trigger condition may be a condition that, during the preset period, the total number of times the character object of user A having input an instruction this time has performed the same action X for the character object of user B1 exceeds a fifth predetermined number. The predetermined trigger condition may be a condition that, during the preset period, the total number of times the character object of user A having input an instruction this time has performed a certain action for the character object of user B1 exceeds the fifth predetermined number. Regarding this trigger condition, “action” that the character object of user A performs is any type of action if the character object of user A can perform.

The predetermined trigger condition may be a condition that, during the preset period, the number of users that have provided an instruction to perform action X for the character object of user B1 exceeds a predetermined number. The predetermined trigger condition may be a condition that, during the preset period, all the users in the same communication group, except for user B1, have provided an instruction to perform action X for the character object of user B1.

The predetermined trigger condition may be a condition that user B1 whose character object is to be subjected to the action performed by the character object of user A based on an instruction from user A has agreed that other character objects perform action on the character object of user B1. The predetermined trigger condition may be a condition that user A having input an instruction this time has agreed that the character objects of other users perform action on the character object of user B1.

The predetermined trigger condition may be a condition that the number of users having a predetermined relationship with user A having input an instruction this time exceeds a first predetermined number. The predetermined trigger condition may be a condition that the number of users having a predetermined relationship with user B1 whose character object is to be subjected to the action of the character object of user A in response to an instruction from user A exceeds the first predetermined number.

### Fifth Modified Example

If a predetermined display condition is satisfied, the change option buttons 901 included in the selection screen 900 displayed on the terminal device 2 of user A (as shown in FIG. 9A) may be modified. Similar to the modification of change option buttons 901, the reaction selection buttons 1711 included in user output image 812a of selection screen 1710 (as shown in FIG. 17B) may be modified if a predetermined display condition is satisfied. For example, in the case of change option buttons 901, if a condition regarding the relationship between user A and user B1 whose character object is displayed on the selection screen 900 is satisfied, the content of the actions corresponding to the change option buttons 901 and the number of change option buttons 901 may be changed. The condition regarding the relationship between user A and user B1 may be that user A and user B1 are mutual followers or not mutual followers, the total time for which user A and user B1 have participated in the same communication service exceeds a predetermined time or does not exceed the predetermined time, and/or the total time for which user A has viewed streaming images distributed by user B1 and for which user B1 has viewed streaming images distributed by user A exceeds a predetermined time or does not exceed the predetermined time.

If a condition for information concerning user A is satisfied, the content of the actions corresponding to the change option buttons 901 and the number of change option buttons 901 in the selection screen 900 may be changed. The condition for information concerning user A may be that the number of followers of user A exceeds a predetermined number or does not exceed the predetermined number and/or the total time for which user A has shared with other users in the same communication service exceeds a predetermined time or does not exceed the predetermined time. Similar to the change of content actions corresponding to change option buttons 901, a content of actions corresponding to the reaction selection buttons 1711 may be changed if a condition for information concerning user A is satisfied.

### Sixth Modified Example

If a character object is generated based on three-dimensional model data for generating three-dimensional animation, a user output image of a user may be an image obtained by viewing the character object, which is a three-dimensional object disposed in a virtual space preset for this user, from a predetermined viewpoint in the virtual space. For example, the display processor 274 disposes a two-dimensional screen in the direction of the predetermined viewpoint, projects the three-dimensional coordinates of various three-dimensional objects disposed in the virtual space onto the two-dimensional screen, and displays the image on the two-dimensional screen on which the various objects are projected as a user output image. The direction of the predetermined viewpoint is a direction toward the character object. The two-dimensional screen is moved when the predetermined viewpoint is shifted and is also rotated when the predetermined viewpoint is rotated in the direction of the predetermined viewpoint.

The display processor 274 may control the shifting of the predetermined viewpoint and/or the rotation of the predetermined viewpoint in the direction of the predetermined viewpoint in accordance with a certain operation performed on a communication screen. The display processor 274 may include an automatic shifting button for automatically shifting the predetermined viewpoint in the communication screen. In this case, if, for example, user A selects the automatic shifting button by operating the input unit 24, the display processor 274 may automatically shift the predetermined viewpoint in accordance with a predetermined shifting rule.

### Seventh Modified Example

If a character object is generated based on three-dimensional model data for generating three-dimensional animation, a user output image of a user may be an image obtained by viewing a virtual space which is preset for all users from a user viewpoint located at a predetermined position of the character object (the position of the eyes of the character object, for example). The character object is a three-dimensional object disposed in the virtual space. In response to a user operation and/or automatically, the user viewpoint may be shifted from the predetermined position of the character object and be located at another position, such as the back, top, or forward of the character object.

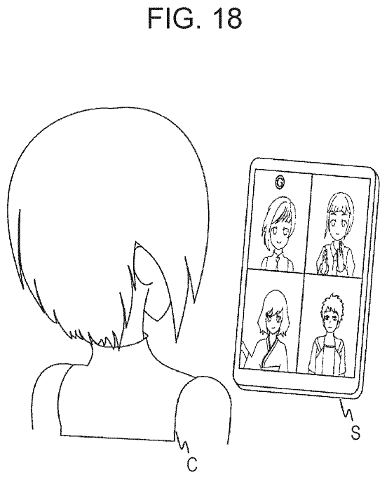

An example of the use of a communication service in a virtual space set for all users will be discussed below. For example, as shown in FIG. 18, the display processor 274 projects, in a virtual space, a device object S, such as a tablet PC, within a viewing range from the user viewpoint of a character object C of user A. On the display portion of the device object S, various screens, such as those discussed with reference to FIGS. 6A through 15B, 17A, and 17B, are displayed. In this case, a user output image of user A displayed on the display portion of the device object S is a two-dimensional image obtained by viewing the virtual space from a virtual camera disposed at a predetermined position of the device object S. Voice data of user A is data obtained by the microphone 26 of the terminal device 2.

The sender 272 of the terminal device 2 sends the user output image of user A, voice data of user A, and user ID of user A to the terminal devices 2 of all users B via the server device 3. Instead of the user output image, the sender 272 may send information on the position of the virtual camera and the viewpoint direction in the virtual space, information on the position of the character object of user A and the orientation of the body of the character object in the virtual space, and motion data of user A. The terminal device 2 of user A receives the user output images of users B, voice data of users B, and user IDs of users B from the terminal devices 2 of users B via the server device 3. The display processor 274 of the terminal device 2 of user A displays the user output images of users B on the display portion of the device object S and outputs voice data of users B from the terminal device 2. A communication service using the virtual device object S can be implemented in this manner.

### Eighth Modified Example

At least some of the functions executed by the terminal processing unit 27 of the terminal device 2 may be implemented by a processor other than the terminal processing unit 27 of the terminal device 2. For example, at least some of the functions executed by the terminal processing unit 27 of the terminal device 2 may be implemented by the server processing unit 33 of the server device 3. For example, some of the functions of the generator 271 and the display processor 274 may be implemented by the server device 3. In one example, the terminal device 2 sends continuously obtained imaging data and voice data to the server device 3, together with the user ID of a user operating the terminal device 2. The server device 3 then generates character video data by using the functions of the generator 271 and generates display information for displaying a communication screen including the user output images of all users on the display unit 23 by using the functions of the display processor 274. The server device 3 then sends the display information to the terminal devices 2 of all users, together with sound information (voice data). The terminal devices 2 then output various items of information received from the server device 3. This is called server rendering.

### Ninth Modified Example

The terminal device 2 has a function of displaying various screens, such as a communication screen, by executing various instructions included in a control program stored in the terminal device 2. To implement a communication service, the terminal device 2 may alternatively call a browser function integrated into a web application, receive a document, such as a webpage described in a markup language (such as a hypertext markup language (HTML)), from the server device 3 by using this browser function, and execute a control program integrated into this webpage. This is called browser rendering. For example, using HTML5 as a markup language enables the terminal device 2 to readily execute new information processing. By employing a webpage application to implement a communication service in a terminal device, a program maker can provide new information processing to a client (terminal device) by merely integrating a new program into a webpage to be sent from a server device. This significantly reduces the number of manufacturing steps of a new program. The client can receive the provision of a new service by merely receiving a webpage without downloading a new control program. This can reduce the load of a communication network, communication cost, and/or communication time, compared with when a control program is downloaded, and can also implement a simplified user interface.

### Tenth Modified Example

The generator 271 of the terminal device 2 of user A may generate output information including face motion data without using imaging data. For example, the terminal storage 22 of the terminal device 2 may store face motion data corresponding to voice data, and the generator 271 may extract the face motion data associated with the obtained voice data of user A from the terminal storage 22 and generate output information including the extracted face motion data, voice data, and user ID of user A. The generator 271 of the terminal device 2 of user A may generate output information including voice data of user A output from the microphone 26 and the user ID stored in the terminal storage 22 without including face motion data. In this case, the display processor 274 of the terminal device 2 of user B may generate face motion data associated with the voice data of user A included in the output information of user A received via the server device 3 and generate animation of the character object of user A. Face motion data corresponding to voice data of a user may be generated by using a lip-sync algorithm.

In this manner, by using the terminal device 2 including an HMD as the display unit 23, user A is able to communicate with user B via their character objects without obtaining imaging data of user A.

### Eleventh Modified Example

On the communication screen 810 shown in FIG. 8B, a record button for providing an instruction to capture the image of a screen may be displayed. For example, while the communication screen 810 is being displayed in the terminal device 2 of user A, when user A selects the record button by operating the input unit 24, the display processor 274 displays one composite output image including the character objects 811a, 811b1, 811b2, and 811b3. The character objects in the composite output image may automatically take a predetermined pose. The sender 272 of the terminal device 2 of user A sends the composite output image to the server device 3. The server device 3 then sends the composite output image to the terminal devices 2 of users B1, B2, and B3. This enables users B1, B2, and B3 to view the composite output image on their terminal devices 2.

The composite output image displayed on the terminal device 2 of user A may be displayed on the entire screen, for example. In this case, in response to user A selecting the record button, the character objects holding a pose may appear without border lines between the individual user output images. The composite output image may be displayed on the terminal device 2 of user A, who has selected the record button, within the display region of the user output image 812a of user A. In this case, the display processor 274 may cause the other character objects of users B1, B2, and B3 to perform an action, such as trying to move to the display region of the user output image 812a of user A. Then, after the lapse of a predetermined time, the composite output image displayed on the terminal device 2 of user A may be displayed on the entire screen.

The composite output image may not necessarily be displayed in response to the selecting of the record button. Instead, the composite output image may be displayed automatically at a predetermined timing, such as in ten minutes after the start of communication. The composite output image may be displayed at a timing at which a predetermined condition is satisfied. Examples of the predetermined condition are that the number of users participating in the same communication service reaches a predetermined number and that the number of instructions provided by a specific user or the total number of instructions provided by all users participating in a communication service reaches a predetermined number.

The displayed composite output image may be provided to user A in response to an operation performed by user A. For example, the displayed composite output image may be stored in the terminal storage 22 of the terminal device 2 of user A. The composite output image received by the terminal device 2 of user B (users B1, B2, and B3) may be provided to user B in response to an operation performed by user B. For example, the composite output image may be stored in the terminal storage 22 of the terminal device 2 of user B. In this manner, the information system 1 can provide a composite output image including the character objects of users participating in a communication service to these users. The users can thus upload the composite output image to linked social media, for example. In this manner, the information system 1 can encourage a user to use a communication service.

What is claimed is:

1. A control method, comprising:
displaying, on a display of a terminal device of a first user, a first image and a second image, the first image including a first object indicating the first user, the second image including a second object indicating a second user, and the second user being different from the first user;
sending, from the terminal device of the first user to a terminal device of the second user via a network, information relating to display of the first image;
sending first audio data of the first user to the terminal device of the second user via the network in a case that the terminal device of the first user obtains the first audio data of the first user;
displaying the first image including the first object as being changed in accordance with an action or the first audio data of the first user;
outputting second audio data of the second user, received via the network, in a case that the terminal device of the first user obtains the second audio data of the second user;
displaying the second image including the second object as being changed in accordance with an action or the second audio data of the second user; and
displaying the first image including the first object as being changed in accordance with an instruction from the first user and displaying the second image as being changed in accordance with the instruction from the first user.

2. The control method according to claim 1, wherein
the displaying the first image including the first object as being changed in accordance with the instruction includes displaying the first image including the first object as performing a first action corresponding to the instruction from the first user, and
the displaying the second image as being changed includes
displaying the second image including the second object which performs a second action, the second action being related to the first action, in accordance with the first action of the first object, or
displaying information regarding the first action of the first object.

3. The control method according to claim 2, wherein the instruction from the first user includes
a first selection instruction to select the first action to be performed by the first object from a plurality of the first actions, and
a second selection instruction to select the second object or to select the second image including the second object.

4. The control method according to claim 3, wherein in a case that a condition relating to a relationship between the first user and the second user is satisfied, a specific first action is added to the plurality of the first actions for selection by the first user.

5. The control method according to claim 3, wherein
the second object is selected as a result of the first user specifying the second object in the displayed second image;
in response to the first user selecting the second object, at least one selection object corresponding to one or more respective first action is displayed; and
the first action to be performed by the first object is a first action corresponding to a selection object selected from the at least one selection object by the first user.

6. The control method according to claim 3, wherein:
the second image including the second object is selected as a result of the first user specifying the displayed second image;
in response to the first user specifying the second image, at least one selection object corresponding to one or more respective first action is displayed; and
the first action, to be performed by the first object, corresponds to a selection object selected from the at least one selection object by the first user.

7. The control method according to claim 3, further comprising:
automatically displaying, on the display of the terminal device of the first user, at least one selection object corresponding to one or more respective first action within the second image during a period starting from when the second image including the second object is displayed, wherein
the first action, to be performed by the first object, corresponds to a selection object selected from the selection objects by the first user; and
the second object is displayed within the second image which includes the selection object selected by the first user.

8. The control method according to claim 2, wherein the second action that the second object performs is selected from at least one second action by the second user on the terminal device of the second user during a period starting from when an instruction for the first object to perform the first action is provided by the first user or starting from when the first object which performs the first action is displayed.

9. The control method according to claim 2, wherein the second action that the second object performs is related to the first action and which is automatically identified when the first action to be performed by the first object is selected by the first user.

10. The control method according to claim 9, further comprising:
receiving information indicating a third action, the third action being selected from at least one third action by the second user on the terminal device of the second user during a period starting from when the first object which performs the first action is displayed; and
displaying the second object which performs the third action indicated by the received information after displaying the second object which performs the second action.

11. The control method according to claim 2, wherein
the displaying the first image including the first object which performs the first action further includes:
displaying, in response to a selection instruction from the first user or the second user, a selection screen for selecting one of a plurality of specific actions,
selecting, in response to the selection instruction, a specific action from the plurality of the specific actions as the first action, and
displaying the first object that performs the selected first action; and
the displaying the second image including the second object which performs the second action further includes:
receiving, from the terminal device of the second user on which the selection screen is displayed, specific action information indicating a specific action selected from the plurality of the specific actions by the second user as the second action, and
displaying the second image including the second object that performs the selected second action indicated by the specific action information.

12. The control method according to claim 2, further comprising:
displaying, in response to a selection instruction from the first user or the second user, a selection screen for selecting one of a plurality of specific actions,
setting a specific action selected from the plurality of the specific actions by the first user to be the first action,
receiving, from the terminal device of the second user on which the selection screen is displayed, specific action information indicating a specific action selected from the plurality of the specific actions by the second user as the second action, and
setting the specific action indicated by the specific action information to be the second action, wherein
the displaying the first image including the first object that performs the first action and the second image including the second object that performs the second action further includes
displaying, in a case that the first action and the second action are set during a period starting from when the selection screen is displayed, the first image including the first object that performs the set first action and the second image including the second object that performs the set second action.

13. The control method according to claim 2, wherein the displaying the second image including the second object which performs the second action further includes
displaying, in a case that a condition relating to a number of times the second object performs the second action is satisfied, the second image including the second object that performs a third action, which is different from the second action, in addition to or instead of execution of the second action, in accordance with the first action of the first object.

14. The control method according to claim 2, wherein the displaying the second image including the second object which performs the second action further includes
displaying, in a case that a predetermined setting is set by the second user, the second image including the second object which does not perform the second action corresponding to the first action of the first object.

15. A control method, comprising:
receiving, by a server device in communication with a terminal device of a first user and a terminal device of a second user, information relating to display of a first image from the terminal device of the first user, the first image including a first object indicating the first user, and receiving information relating to display of a second image from the terminal device of the second user, the second image including a second object indicating the second user;
sending first information for displaying the first image to the terminal device of the second user;
sending second information for displaying the second image to the terminal device of the first user;
sending first audio data of the first user to the terminal device of the second user in a case that the first audio data of the first user is received from the terminal device of the first user;
sending first change information to at least the terminal device of the second user for displaying the first image including the first object as being changed in accordance with a first action or the first audio data of the first user;
sending second audio data of the second user to the terminal device of the first user in a case that the second audio data of the second user is received from the terminal device of the second user;
sending second change information to at least the terminal device of the first user for displaying the second image including the second object as being changed in accordance with a second action or the second audio data of the second user;
receiving instruction information, from the terminal device of the first user, for displaying the first image including the first object as being changed in accordance with an instruction from the first user; and
sending the instruction information to at least the terminal device of the second user for displaying the first image including the first object as being changed in accordance with the instruction and displaying the second image as being changed in accordance with the instruction.

16. A terminal device for a first user, the terminal device comprising:
processing circuitry configured to
control a display to display a first image and a second image, the first image including a first object indicating the first user, the second image including a second object indicating a second user, and the second user being different from the first user;
send information relating to display of the first image to another terminal device of the second user via a network;
send first audio data of the first user to the another terminal device of the second user via the network in a case that the terminal device obtains the first audio data of the first user;
display the first image including the first object as being changed in accordance with an action of the first user;
output second audio data, received via the network, of the second user in a case that the terminal device obtains the second audio data of the second user;
displaying the second image including the second object as being changed in accordance with an action of the second user; and
control the display to display the first image including the first object as being changed in accordance with an instruction from the first user and display the second image as being changed in accordance with the instruction from the first user.

17. The terminal device according to claim 16, wherein
the processing circuitry controls the display to display the first image including the first object as being changed in accordance with the instruction by displaying the first image including first object as performing a first action corresponding to the instruction from the first user, and
the processing circuitry controls the display to display the second image including the second object as being changed by
displaying the second image including the second object which performs a second action, the second action being related to the first action, in accordance with the first action of the first object, or
displaying information regarding the first action of the first object.

18. The terminal device according to claim 17, wherein the instruction from the first user includes
a first selection instruction to select the first action to be performed by the first object from a plurality of the first actions, and
a second select instruction to select the second object, or to select the second image including the second object.

19. The terminal device according to claim 18, wherein in a case that a condition relating to a relationship between the first user and the second user is satisfied, a specific first action is added to the plurality of the first actions for selection by the first user.

20. A server device in communication with a terminal device of a first user and a terminal device of a second user, the server device comprising:
processing circuitry configured to
receive information relating to display of a first image from the terminal device of the first user, the first image including a first object indicating the first user, and receiving information relating to display of a second image from the terminal device of the second user, the second image including a second object indicating the second user;
send first information for displaying the first image to the terminal device of the second user;
send second information for displaying the second image to the terminal device of the first user;
send first audio data of the first user to the terminal device of the second user in a case that the first audio data of the first user is received from the terminal device of the first user;
send first change information to at least the terminal device of the second user for displaying the first image including the first object as being changed in accordance with a first action or the first audio data of the first user;
send second audio data of the second user to the terminal device of the first user in a case that the second audio data of the second user is received from the terminal device of the second user;
send second change information to at least the terminal device of the first user for displaying the second image including the second object as being changed in accordance with a second action or the second audio data of the second user;
receive instruction information, from the terminal device of the first user, for displaying the first image including the first object as being changed in accordance with an instruction from the first user; and
send the instruction information to at least the terminal device of the second user for displaying the first image including the first object as being changed in accordance with the instruction and displaying the second image as being changed in accordance with the instruction.
